(19) United States
(12) Patent Application Publication
(10) Pub. No.: US 2026/0016705 A1
(43) Pub. Date: Jan. 15, 2026

(54) EYEGLASS FRAME

(71) Applicant: CONTOUR OPTIK INC., Minxiong Township (TW)

(72) Inventors: David CHAO, Saratoga, CA (US); Chien-Liang YEH, Minxiong Township (TW)

(21) Appl. No.: 18/975,204

(22) Filed: Dec. 10, 2024

(30) Foreign Application Priority Data
Jul. 9, 2024 (CN) 202421616760.0

(51) Int. Cl. G02C 5/14; G02C 5/22

(52) U.S. Cl. CPC G02C 5/146; G02C 5/2227

(57) ABSTRACT

An eyeglass frame includes a lens frame, two temple-connecting arms having front ends disposed respectively and rotatably on left and right sides of the lens frame and each including a groove and a shaft hole, two temples having front ends disposed respectively and rotatably on rear ends of the temple-connecting arms, and a hinge assembly including two shaft seats respectively disposed on the left and right sides of the lens frame and each having a seat body and a seat hole, two shaft pins each inserted into aligned shaft hole and seat hole, two biasing members respectively disposed in the grooves of the temple-connecting arms, and two pressing members each abutting between one of the biasing members and the seat body of a corresponding shaft seat and capable of abutting against different surfaces of the seat body when each temple-connecting arm is rotated relative to the lens frame.

### CROSS-REFERENCE TO RELATED APPLICATION

This application claims priority to Chinese Utility Model Patent Application No. 202421616760.0, filed on Jul. 9, 2024, and incorporated by reference herein in its entirety.

### FIELD

The disclosure relates to an eyeglass frame of eyeglasses.

### BACKGROUND

Conventional eyeglasses are designed such that the temples thereof can rotate left and right relative to an eyeglass frame, so that the user can use the eyeglasses when the temples are unfolded, and can store the eyeglasses when the temples are folded. However, if the conventional eyeglasses are subjected to external forces from a front-rear direction and an up-down direction when the temples are unfolded, the overall structure thereof will be difficult to appropriately change the structural form thereof in response to the external forces because of the limited rotational direction of the temples, and this may lead to permanent deformation or fracture damage to the structure of the conventional eyeglasses.

### SUMMARY

Therefore, an object of the present disclosure is to provide an eyeglass frame that can alleviate at least one of the drawbacks of the prior art.

According to a first aspect of this disclosure, the eyeglass frame includes a lens frame, two temple-connecting arms, two temples, and a hinge assembly. The temple-connecting arms have front ends disposed respectively and rotatably on left and right sides of the lens frame, and rear ends opposite to the front ends. Each temple-connecting arm includes a first groove extending inwardly from the front end, and a first shaft hole formed in the front end and communicating transversely with the first groove. The temples have front ends disposed respectively and rotatably on the rear ends of the temple-connecting arms. A rotating direction of each temple relative to the respective temple-connecting arm is different from a rotating direction of each temple-connecting arm relative to the lens frame.

The hinge assembly includes two first shaft seats respectively disposed on the left and right sides of the lens frame, two first shaft pins, two first biasing members, and two first pressing members. Each first shaft seat has a first seat body inserted into the first groove of the respective temple-connecting arm, and a first seat hole formed in the first seat body and aligned with the first shaft hole of the respective temple-connecting arm. Each first shaft pin is inserted into the first shaft hole of the respective temple-connecting arm and the aligned first seat hole. The first biasing members are respectively disposed in the first grooves of the temple-connecting arms, and have front ends respectively facing the first seat bodies of the first shaft seats. Each first pressing member is disposed between and abutting against the front end of one of the first biasing members and the first seat body of a corresponding first shaft seat. Each first pressing member is capable of abutting against different surfaces of the first seat body of a respective first shaft seat when each temple-connecting arm is rotated relative to the lens frame. Each first biasing member generates different biasing forces according to different abutment positions of each of the first pressing members.

According to a second aspect of this disclosure, the eyeglass frame includes a lens frame, two temple-connecting arms, two temples, and a hinge assembly. The temple-connecting arms have front ends connected respectively and rotatably on left and right sides of the lens frame, and rear ends opposite to the front ends. Each temple-connecting arm includes a groove extending inwardly from the front end and along a length of a respective temple-connecting arm, and a shaft hole formed in the front end and communicating transversely with the groove. The temples have front ends disposed respectively and rotatably on the rear ends of the temple-connecting arms. A rotating direction of each temple relative to the respective temple-connecting arm is different from a rotating direction of each temple-connecting arm relative to the lens frame. Each temple includes an accommodating groove extending inwardly from the front end and along a length of a respective temple, and a shaft hole formed in the front end of the respective temple and communicating transversely with the accommodating groove.

The hinge assembly includes two first shaft seats respectively disposed on the left and right sides of the lens frame, two first shaft pins, two second shaft seats, two second shaft pins, two first biasing members, two second biasing members, two first pressing members, and two second pressing members. Each first shaft seat has a first seat body inserted into the groove of the respective temple-connecting arm, and a first seat hole formed in the first seat body and aligned with the shaft hole of the respective temple-connecting arm. Each first shaft pin is inserted into the shaft hole of the respective temple-connecting arm and the aligned first seat hole. The second shaft seats are respectively disposed on the rear ends of the temple-connecting arms. Each second shaft seat has a second seat body protruding from the rear end of the respective temple-connecting arm and inserted into the accommodating groove of the respective temple, and a second seat hole formed in the second seat body and aligned with the shaft hole of the respective temple. Each second shaft pin is inserted into the shaft hole of the respective temple and the aligned second seat hole. An extending direction of each second shaft pin is different from an extending direction of each first shaft pin.

The first biasing members are respectively disposed in the grooves of the temple-connecting arms, and have front ends respectively facing the first seat bodies of the first shaft seats. The second biasing members are respectively disposed in the accommodating grooves of the temples, and have front ends respectively facing the second seat bodies of the second shaft seats. Each first pressing member is disposed between and abuts against the front end of one of the first biasing members and the first seat body of a corresponding first shaft seat. Each first pressing member is capable of abutting against different surfaces of the first seat body of a respective first shaft seat when each temple-connecting arm is rotated relative to the lens frame. Each first biasing member generates different biasing forces according to different abutment positions of each first pressing member.

Each second pressing member is disposed between and abuts against the front end of one of the second biasing members and the second seat body of a corresponding second shaft seat. Each second pressing member is capable of abutting against different surfaces of the second seat body of a respective second shaft seat when each temple is rotated relative to the respective temple-connecting arm. Each second biasing member generates different biasing forces according to different abutment positions of each second pressing member.

According to a third aspect of this disclosure, the eyeglass frame includes a lens frame, two temple-connecting arms, two temples, and a hinge assembly. The temple-connecting arms have front ends disposed respectively and rotatably on left and right sides of the lens frame, and rear ends opposite to the front ends. Each temple-connecting arm includes a first shaft hole formed in the front end. The temples have front ends disposed respectively and rotatably on the rear ends of the temple-connecting arms. A rotating direction of each temple relative to the respective temple-connecting arm is different from a rotating direction of each temple-connecting arm relative to the lens frame. The hinge assembly includes two first shaft seats, two first shaft pins, and two magnetic positioning units.

The first shaft seats are respectively mounted on the left and right sides of the lens frames. Each first shaft seat has a first seat hole aligned with the first shaft hole of the respective temple-connecting arm. Each first shaft pin is inserted into the first shaft hole of the respective temple-connecting arm and the aligned first seat hole. Each magnetic positioning unit includes a first magnetic member disposed in one of the first shaft seat and the lens frame, and a second magnetic member disposed in a corresponding temple-connecting arm. The first and second magnetic members are magnetically attracted to each other when each temple-connecting arm is rotated relative to the lens frame to a predetermined position.

According to a fourth aspect of this disclosure, the eyeglass frame includes a lens frame, two temple-connecting arms, two temples, and a hinge assembly. The temple-connecting arms have front ends disposed respectively and rotatably on left and right sides of the lens frame, and rear ends opposite to the front ends. Each temple-connecting arm includes a first groove extending inwardly from the front end, and a first shaft hole formed in the front end and communicating transversely with the first groove. The temples have front ends disposed respectively and rotatably on the rear ends of the temple-connecting arms. A rotating direction of each temple relative to the respective temple-connecting arm is different from a rotating direction of each temple-connecting arm relative to the lens frame

The hinge assembly includes two first shaft seats respectively disposed on the left and right sides of the lens frame, and two first shaft pins. Each first shaft seat has a first seat body inserted into the first groove of the respective temple-connecting arm, and a first seat hole formed in the first seat body and aligned with the first shaft hole of the respective temple-connecting arm. The first seat body has a planar first positioning surface, and a curved first sliding surface connected to the planar first positioning surface. Each first shaft pin is inserted into the first shaft hole of the respective temple-connecting arm and the aligned first seat hole.

According to a fifth aspect of this disclosure, the eyeglass frame includes a lens frame, two temple-connecting arms, two temples, and a hinge assembly. The temple-connecting arms have front ends disposed respectively and rotatably on left and right sides of the lens frame, and rear ends opposite to the front ends. The temples having front ends disposed respectively and rotatably on the rear ends of the temple-connecting arms. A rotating direction of each temple relative to the respective temple-connecting arm is different from a rotating direction of each temple-connecting arm relative to the lens frame.

The hinge assembly includes two first shaft seats respectively disposed on the left and right sides of the lens frame, and two clamping elastic pieces respectively mounted on the front ends of the temple-connecting arms. Each first shaft seat has a pivot portion with a polygonal cross-section. Each clamping elastic piece has a chuck structure that corresponds in shape to the pivot portion and that elastically clamps the pivot portion.

### BRIEF DESCRIPTION OF THE DRAWINGS

Other features and advantages of the disclosure will become apparent in the following detailed description of the embodiments with reference to the accompanying drawings. It is noted that various features may not be drawn to scale.

FIG. 1 is a schematic top view of an eyeglass frame according to the first embodiment of the present disclosure.

FIG. 2 is a fragmentary side view of the first embodiment.

FIG. 3 is an exploded side view of a hinge assembly and a temple-connecting arm of the first embodiment.

FIG. 4 is a schematic top view of an eyeglass frame according to the second embodiment of the present disclosure.

FIG. 5 is a fragmentary side view of the second embodiment.

FIG. 6 is an exploded side view of a hinge assembly and a temple-connecting arm of the second embodiment.

FIG. 7 is a view similar to FIG. 4, but illustrating an alternative form of the second embodiment.

FIG. 8 is a fragmentary side view of the alternative form of the second embodiment.

FIG. 9 is an exploded side view of a hinge assembly and a temple-connecting arm of the alternative form of the second embodiment.

FIG. 10 is a schematic top view of an eyeglass frame according to the third embodiment of the present disclosure.

FIG. 11 is a fragmentary side view of the third embodiment.

FIG. 12 is an exploded side view of a hinge assembly and a temple-connecting arm of the third embodiment.

FIG. 13 is a view similar to FIG. 10, but illustrating a first alternative form of the third embodiment.

FIG. 14 is a fragmentary side view of the first alternative form of the third embodiment.

FIG. 15 is an exploded side view of a hinge assembly and a temple-connecting arm of the first alternative form of the third embodiment.

FIG. 16 is a view similar to FIG. 10, but illustrating a second alternative form of the third embodiment.

FIG. 17 is a fragmentary side view of the second alternative form of the third embodiment.

FIG. 18 is an exploded side view of a hinge assembly and a temple-connecting arm of the second alternative form of the third embodiment.

FIG. 19 is a view similar to FIG. 10, but illustrating a third alternative form of the third embodiment.

FIG. 20 is a fragmentary side view of the third alternative form of the third embodiment.

FIG. 21 is an exploded side view of a hinge assembly and a temple-connecting arm of the third alternative form of the third embodiment.

FIG. 22 is a schematic top view of an eyeglass frame according to the fourth embodiment of the present disclosure.

FIG. 23 is a fragmentary side view of the fourth embodiment.

FIG. 24 is an exploded side view of a hinge assembly and a temple-connecting arm of the fourth embodiment.

FIG. 25 is a view similar to FIG. 22, but illustrating an alternative form of the fourth embodiment.

FIG. 26 is a fragmentary side view of the alternative form of the fourth embodiment.

FIG. 27 is an exploded side view of a hinge assembly and a temple-connecting arm of the alternative form of the fourth embodiment.

FIG. 28 is a schematic top view of an eyeglass frame according to the fifth embodiment of the present disclosure.

FIG. 29 is a fragmentary side view of the fifth embodiment.

FIG. 30 is an exploded side view of a hinge assembly and a temple-connecting arm of the fifth embodiment.

FIG. 31 is a view similar to FIG. 28, but illustrating an alternative form of the fifth embodiment.

FIG. 32 is a fragmentary side view of the alternative form of the fifth embodiment.

FIG. 33 is an exploded side view of a hinge assembly and a temple-connecting arm of the alternative form of the fifth embodiment.

FIG. 34 is a schematic top view of an eyeglass frame according to the sixth embodiment of the present disclosure.

FIG. 35 is a fragmentary side view of the sixth embodiment.

FIG. 36 is an exploded side view of a hinge assembly and a temple-connecting arm of the sixth embodiment.

FIG. 37 is a view similar to FIG. 34, but illustrating an alternative form of the sixth embodiment.

FIG. 38 is a fragmentary side view of the alternative form of the sixth embodiment.

FIG. 39 is an exploded side view of a hinge assembly and a temple-connecting arm of the alternative form of the sixth embodiment.

FIG. 40 is a schematic top view of an eyeglass frame according to the seventh embodiment of the present disclosure.

FIG. 41 is a fragmentary side view of the seventh embodiment.

FIG. 42 is an exploded side view of a hinge assembly and a temple-connecting arm of the seventh embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

### First Embodiment

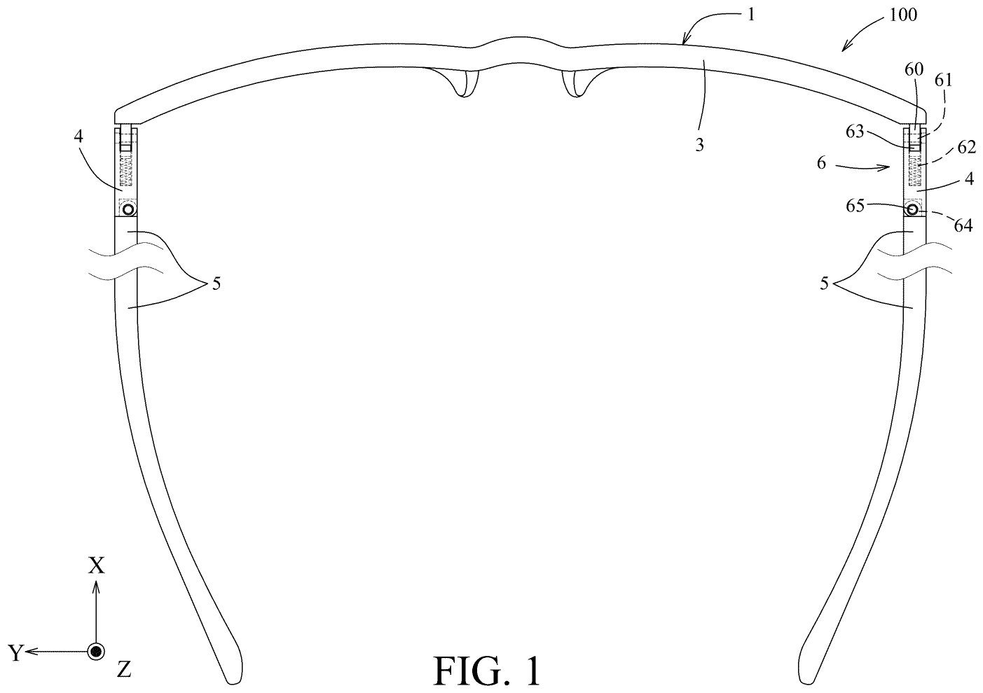

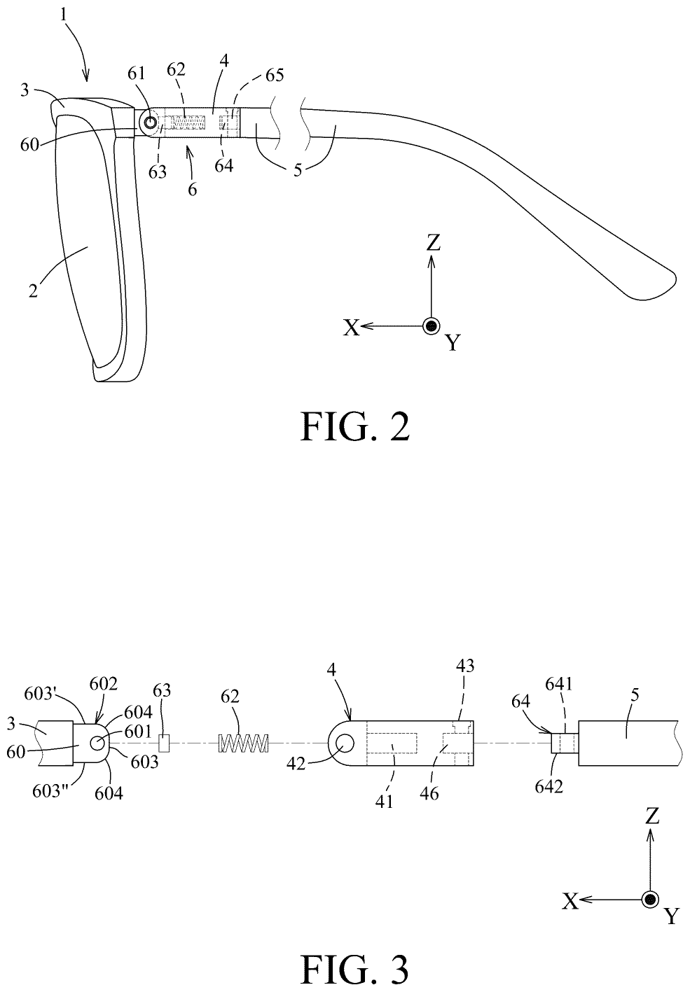

FIG. 1 illustrates eyeglasses 100 configured to be worn by a user and including an eyeglass frame 1 according to the first embodiment of the present disclosure, and two lenses 2 (only one lens 2 is shown in FIG. 2) mounted on the eyeglass frame 1.

The eyeglass frame 1 includes a lens frame 3, two temple-connecting arms 4, two temples 5, and a hinge assembly 6. The lens frame 3 is one of the main structures of the eyeglass frame 1, and is used for mounting the lenses 2.

Each temple-connecting arm 4 has opposite front and rear ends. Front ends of the temple-connecting arms 4 are disposed rotatably and respectively on left and right sides of the lens frame 3. Each temple-connecting arm 4 includes a first groove 41 extending inwardly from the front end and along a length thereof, a second groove 46 extending inwardly from the rear end, a first shaft hole 42 that is formed in the front end, that extends in a left-right direction (Y), and that communicates transversely with the first groove 41, and a second shaft hole 43 that is formed in the rear end, that extends in an up-down direction (Z), and that communicates transversely with the second groove 46. In this embodiment, the first and second grooves 41, 46 extend along a same straight line, and do not communicate with each other.

Front ends of the temples 5 are disposed rotatably and respectively on the rear ends of the temple-connecting arms 4. A rotating direction of each temple 5 relative to the respective temple-connecting arm 4 is different from a rotating direction of each temple-connecting arm 4 relative to the lens frame 3. Specifically, in this embodiment, each temple-connecting arm 4 is rotatable relative to the lens frame 3 in the up-down direction (Z), while each temple 5 is rotatable relative to the respective temple-connecting arm 4 in the left-right direction (Y). Thus, whether the eyeglasses 100 are subjected to external forces from a front-rear direction (X), the left-right direction (Y), and the up-down direction (Z), the eyeglass frame 1 of the eyeglasses 100 can produce corresponding structural changes through rotations of the temple-connecting arms 4 and/or the temples 5, so that the eyeglasses 100 can adapt to external forces to the greatest extent, thereby preventing the structure of the eyeglasses 100 from permanent deformation and fracture damage.

The hinge assembly 6 includes two first shaft seats 60, two first shaft pins 61, two first biasing members 62, two first pressing members 63, two second shaft seats 64 and two second shaft pins 65.

The first shaft seats 60 are respectively disposed on the left and right sides of the lens frame 3. Each first shaft seat 60 has a first seat body 602 protruding from a respective one of the left and right sides of the lens frame 3 and inserted into the first groove 41 of the respective temple-connecting arm 4 and having a non-arcuate shape, and a first seat hole 601 formed in the first seat body 62 and aligned with the first shaft hole 42 of the respective temple-connecting arm 4. The first seat body 602 has at least one planar first positioning surface 603, and at least one curved first sliding surface 604 connected to the first positioning surface 603. Specifically, in this embodiment, the first seat body 602 has three planar first positioning surfaces 603, 603′, 603″ respectively located at rear, top, and bottom sides thereof, and two curved first sliding surfaces 604 each connected between two adjacent ones of the first positioning surfaces 603, 603′, 603″. However, the number and position of each of the first positioning surface 603 and the first sliding surface 604 may be adjusted according to actual requirements, and are not limited to what is disclosed herein.

Each first shaft pin 61 is inserted into the first shaft hole 42 of the respective temple-connecting arm 4 and the aligned first seat hole 601. In this embodiment, the first shaft pin 61 extends in the left-right direction (Y). As such, each first shaft pin 61 can serve as a rotation axis for each temple-connecting arm 4 to rotate relative to the lens frame 3 in the up-down direction (Z).

The first biasing members 62 are respectively disposed in the first grooves 41 of the temple-connecting arms 4. Each first biasing member 62 has a front end facing the first seat body 602 of a respective one of the first shaft seats 60, and a rear end fixed inside the first groove 41. In this embodiment, each first biasing member 62 is, for example, a compression spring which can generate an elastic biasing force corresponding to different amount of deformation.

Each first pressing member 63 is disposed between and abuts against the front end of one of the first biasing members 62 and the first seat body 602 of a corresponding one of the first shaft seats 60. In this embodiment, each first pressing member 63 is, for example, a quadrilateral rod. Each first pressing member 63 is capable of abutting against different surfaces of the first seat body 602 of the corresponding first shaft seat 60 when each temple-connecting arm 4 is rotated relative to the eyeglass frame 3, so that each first biasing member 62 can generate different biasing forces according to different abutment positions of each first pressing member 63.

With reference to FIG. 3, in this embodiment, since the first positioning surface 603 located at the rear side of the first seat body 602 (i.e., rear first positioning surface 603), the two first sliding surfaces 604, and the first positioning surface 603′ or 603″ located at the top or bottom side of the first seat body 602 (i.e., top first positioning surface 603′ or bottom first positioning surface 603″) are spaced apart from the center of the first shaft hole 42 by a distance that gradually increases, when the first pressing member 63 abuts against the rear first positioning surface 603, the first biasing member 62 will have a minimum biasing force; and, when the first pressing member 63 abuts against the top or bottom first positioning surface 603′ or 603″, the first biasing member 62 will have a maximum biasing force. Furthermore, since each first sliding surface 604 is curved and has a gradual spacing from the center of the first shaft hole 42, when the first pressing member 63 abuts against one of the first sliding surfaces 604, the first pressing member 63 will slide toward the rear first positioning surface 603 under the biasing force of the first biasing member 62, so that the temple-connecting arm 4 can automatically rotate from a state where the rear end thereof is slightly upward or slightly downward to a state where the rear end thereof faces rearward. In this way, the rear end of the temple-connecting arm 4, which is in the rearward facing state, is consistent with the conventional wearing requirement of a user. On the other hand, since the first positioning surfaces 603, 603′, 603″ are planar, when the first pressing member 63 abuts against either one of the rear, top and bottom first positioning surface 603, 603′, 603″, the first biasing member 62 is allowed to maintain a fixed biasing force, and at this time, because the first pressing member 63 is clamped between the first biasing member 62 and the corresponding rear, top and bottom first positioning surfaces 603, 603′, 603″, the temple-connecting arm 4 cannot rotate relative to the lens frame 3 without the presence of an external force. Therefore, when the temple-connecting arm 4 is not subjected to any external force, the rear end thereof can be maintained in a state where it faces rearward, upward, or downward.

The second shaft seats 64 are respectively disposed on the front ends of the temples 5. Each second shaft seat 64 has a second seat body 642 protruding from the front end of the respective temple 5 and inserted into the second groove 46 of the respective temple-connecting arm 4 and having a non-arcuate shape, and a second seat hole 641 formed in the second seat body 642 and aligned with the second shaft hole 43 of the respective temple-connecting arm 4.

Each second shaft pin 65 is inserted into the second shaft hole 43 of the respective temple-connecting arm 4 and the aligned second seat hole 641. An extending direction of each second shaft pin 65 is different from that of each first shaft pin 61. In this embodiment, each second shaft pin 65 extends in the up-down direction (Z). As such, each second shaft pin 65 can serve as a rotation axis for each temple 5 to rotate relative to the respective temple-connecting arm 4 in the left-right direction (Y).

According to the preceding description, in the first embodiment, the eyeglass frame 1 is configured based on the arrangement of the temple-connecting arms 4, the temples 5, and the hinge assembly 6, so that an actuating mechanism that allows the temple-connecting arms 4 to rotate relative to the lens frame 3 in the up-down direction (Z) and the temples 5 to rotate relative to the respective temple-connecting arms 4 in the left-right direction (Y) can be achieved. Thus, regardless of which direction the eyeglasses 100 are subjected to external forces, the eyeglass frame 1 of the eyeglasses 100 can adaptively change the structural form thereof, thereby preventing the structure of the eyeglasses 100 from permanent deformation and fracture damage. Moreover, through the dispositions of the first seat bodies 602 of the first shaft seats 60, the first biasing members 62, and the first pressing members 63, the temple-connecting arms 4 can be structurally positioned at different rotational positions relative to the lens frame 3 or can automatically restore to a position in which the rear ends thereof face rearward so as to meet the various usage requirements of the user.

### Second Embodiment

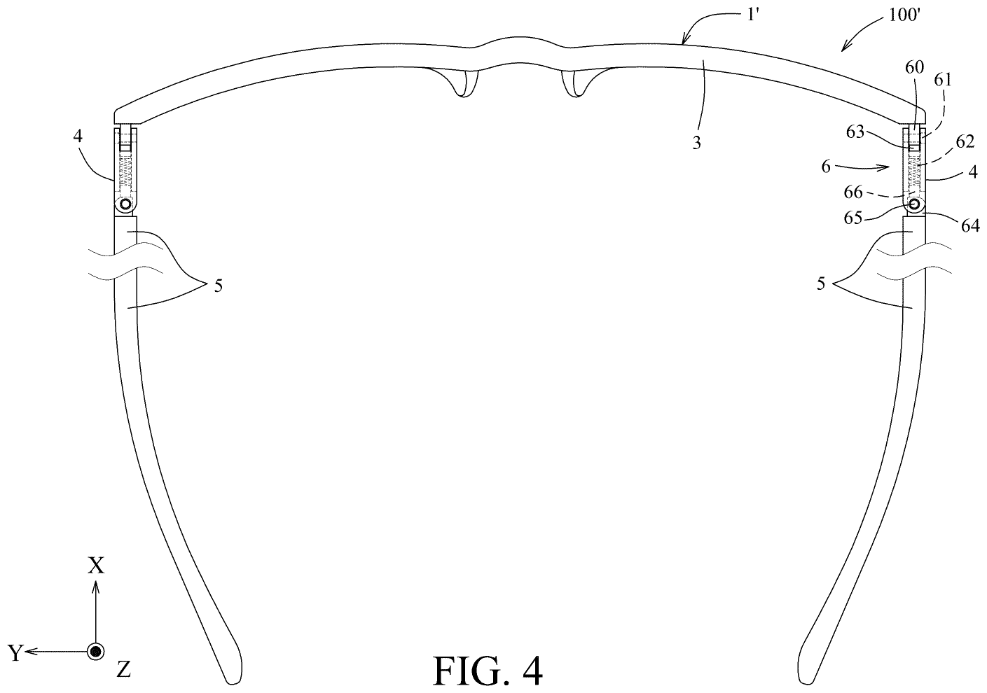

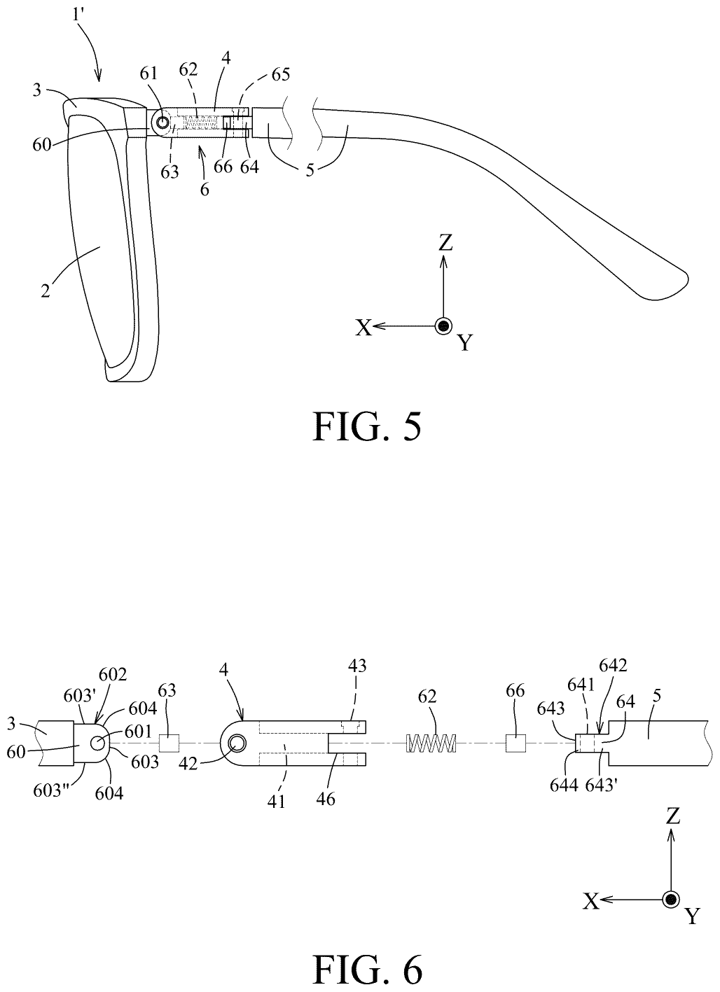

Referring to FIGS. 4 to 6, the second embodiment of the eyeglass frame 1′ of the eyeglasses 100′ of this disclosure is shown to be substantially identical to the first embodiment, and differs from the first embodiment in the structures of the temple-connecting arms 4 and the hinge assembly 6.

In this embodiment, the first and second grooves 41, 46 of each temple-connecting arm 4 extend along the same straight line, and communicate with each other to form a through hole that extends along the length thereof and that has two openings respectively facing forward and rearward, and the hinge assembly 6 further includes two second pressing members 66. The second seat body 642 of each second shaft seat 64 has at least one planar second positioning surface 643, and at least one curved second sliding surface 644 connected to the second positioning surface 643. Specifically, in this embodiment, the second seat body 642 has three planar second positioning surfaces 643, 643′, 643″ respectively located at front, left and right sides thereof (the second positioning surface 643″ located at the right side thereof is not visible in FIG. 6), and two curved second sliding surfaces 644 (only one is visible in FIG. 6) each connected between two adjacent ones of the second positioning surfaces 643, 643′, 643″. Furthermore, the structure and function of the second seat body 642, the second positioning surfaces 643, 643′, 643″, and the second sliding surfaces 644 are respectively similar to those of the first seat body 602, the first positioning surfaces 603, 603′, 603″, and the first sliding surfaces 604.

Like the first embodiment, each second shaft pin 65 is inserted into the aligned second shaft hole 43 and second seat hole 641, and each first pressing member 63 is disposed between and abuts against the front end of one of the first biasing members 62 and the first seat body 602 of the corresponding first shaft seat 60. However, unlike the first embodiment, the first biasing members 62 are respectively disposed in the through holes formed by the first and second grooves 41, 46 of the temple-connecting arms 4 such that the front ends of the first biasing members 62 respectively abut against the first pressing members 63, and the rear ends thereof respectively face the second positioning surfaces 643 of the second seat bodies 642 of the respective second shaft seats 64 that are located at the front sides thereof (i.e., front second positioning surfaces 643). Thus, each first biasing member 62 can apply an elastic biasing force to the first or second seat body 602, 642 according to different amount of deformation.

Each second pressing member 66 is disposed between and abuts against the rear end of the one of the first biasing members 62 and the front second positioning surface 643 of the second seat body 642 of a corresponding one of the second shaft seats 64. Each second pressing member 66 is capable of abutting against different surfaces of the second seat body 642 of the corresponding second shaft seat 64 when each temple 5 is rotated relative to the respective temple-connecting arm 4, so that each first biasing member 62 can generate different biasing forces according to different abutment positions of each second pressing member 66. In this embodiment, the structure and function of each second pressing member 66 are similar to those of each first pressing member 63. During rotation of each temple 5 relative to the respective temple-connecting arm 4, each second pressing member 66 is allowed to abut against the front, left or right second positioning surface 643, 643′ or 643″ or one of the second sliding surfaces 644 of the second seat body 642 of the corresponding second shaft seat 64. When each second pressing member 66 abuts against the front, left or right second positioning surface 643, 643′, 643″, the rear end of each temple 5 can be maintained at a rearward, leftward, or rightward state. When each second pressing member 66 abuts against one of the second sliding surfaces 644, each temple 5 is caused to rotate to a state in which the rear end thereof faces rearward through the biasing force of the respective first biasing member 62, thereby meeting the conventional wearing requirement of the user.

According to the preceding description, in the second embodiment, the eyeglass frame 1′ is configured based on the arrangement of the temple-connecting arms 4, the temples 5, and the hinge assembly 6, so that an actuating mechanism that allows the temple-connecting arms 4 to rotate relative to the lens frame 3 in the up-down direction (Z) and the temples 5 to rotate relative to the respective temple-connecting arms 4 in the left-right direction (Y) can be achieved. Thus, regardless of which direction the eyeglasses 100′ are subjected to external forces, the eyeglass frame 1′ of the eyeglasses 100′ can adaptively change the structural form thereof, thereby preventing the structure of the eyeglasses 100′ from permanent deformation and fracture damage. Moreover, through the dispositions of the first seat bodies 602 of the first shaft seats 60, the second seat bodies 642 of the second shaft seats 64, the first biasing members 62, the first pressing members 63, and the second pressing members 66, the temple-connecting arms 4 can be structurally positioned at different up and down rotational positions relative to the lens frame 3 or automatically restored to a position in which the rear ends thereof face rearward under the biasing forces of the first biasing members 62, and the temples 5 can be structurally positioned at different left and right rotational positions relative to the respective temple-connecting arms 4 or automatically restored to a position in which the rear ends thereof face rearward under the biasing forces of the first biasing members 62, so as to meet the various usage requirements of the user.

### Alternative Form of the Second Embodiment

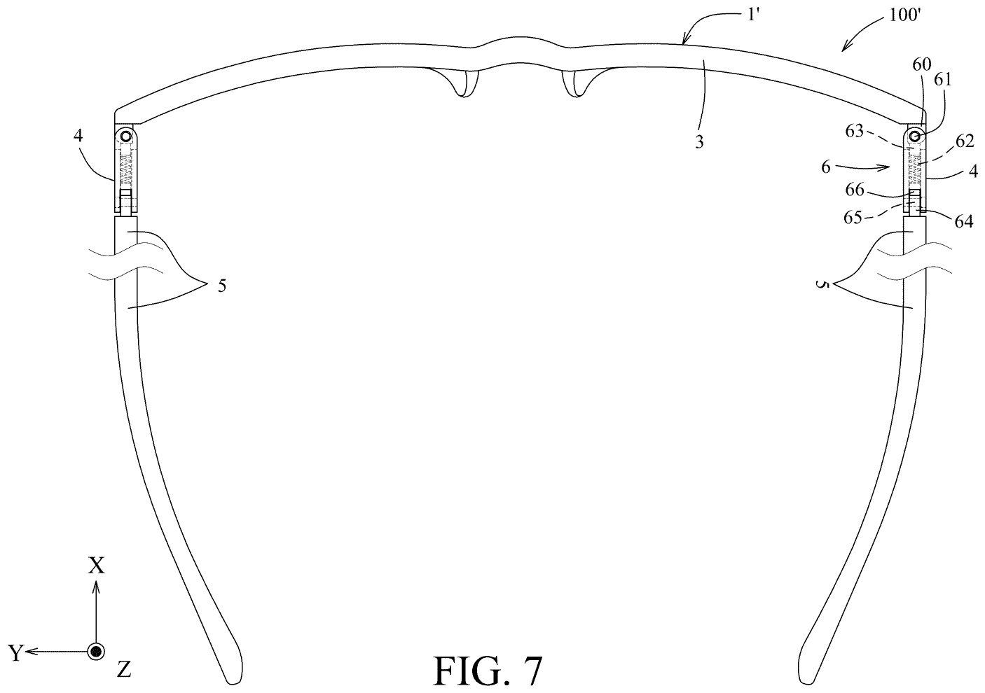

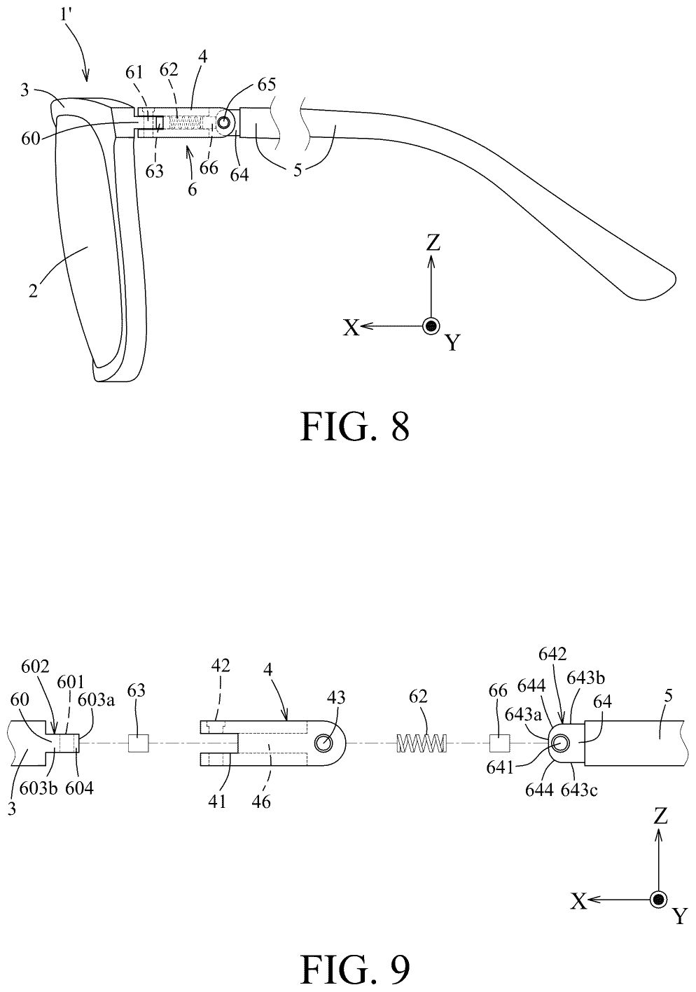

FIGS. 7 to 9 illustrate an alternative form of the second embodiment. In this case, the structures of the first and second shaft seats 60, 64 are interchanged such that each temple-connecting arm 4 is rotatable relative to the lens frame 3 in the left-right direction (Y), and each temple 5 is rotatable relative to the respective temple-connecting arm 4 in the up-down direction (Z). Correspondingly, the first shaft hole 42 of each temple-connecting arm 4 extends in the up-down direction (Z), the second shaft hole 43 of each temple-connecting arm 4 extends in left-right direction (Y), each first shaft pin 61 extends in the up-down direction (Z), and each second shaft pin 65 extends in the left-right direction (Y). Furthermore, the first seat body 602 of each first shaft seat 60 has three planar first positioning surfaces (603a, 603b, 603c) respectively located at rear, left and right sides thereof (the first positioning surface 603c located at the right side thereof is not visible in FIG. 9), and two curved first sliding surfaces 604 each connected between two adjacent first positioning surfaces (603a, 603b, 603c); and the second seat body 642 of each second shaft seat 64 has three planar second positioning surfaces (643a, 643b, 643c) respectively located at front, top and bottom sides thereof, and two curved second sliding surfaces 644 each connected between two adjacent second positioning surfaces (643a, 643b, 643c).

In this alternative form of the second embodiment, although the rotatable directions of each temple-connecting arm 4 and each temple 5 of the eyeglass frame 1′ are different from those of the second embodiment, when the eyeglasses 100′ are subjected to external forces from the front-rear direction (X), the left-right direction (Y), and the up-down direction (Z), the eyeglass frame 1′ of the eyeglasses 100′ can adaptively change the structural form thereof through left and right rotation of the temple-connecting arms 4 and/or up and down rotation of the temples 5, so that permanent deformation and fracture damage of the structure of the eyeglasses 100′ can be similarly prevented. Moreover, through the dispositions of the first seat bodies 602 of the first shaft seats 60, the second seat bodies 642 of the second shaft seats 64, the first biasing members 62, the first pressing members 63, and the second pressing members 66, the temple-connecting arms 4 can be structurally positioned at different left and right positions relative to the lens frame 3 or automatically restored to a position in which the rear ends thereof face rearward under the biasing forces of the first biasing members 62, and the temples 5 can be structurally positioned at different up and down rotational positions relative to the temple-connecting arms 4 or automatically restored to a position in which the rear ends thereof face rearward under the biasing forces of the first biasing members 62, so as to meet the various usage requirements of the user.

### Third Embodiment

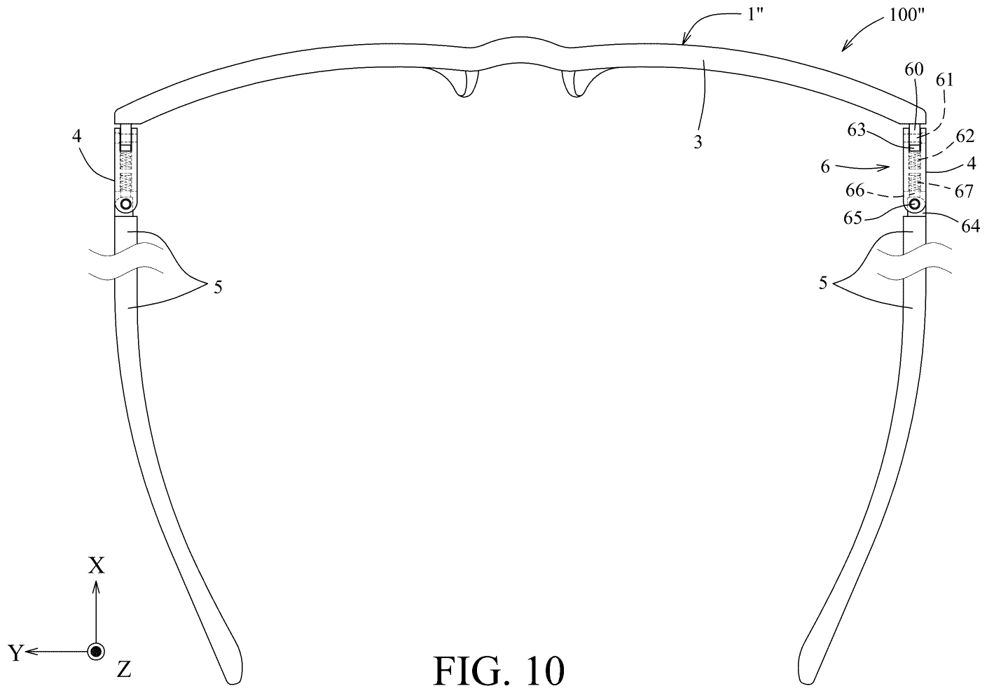

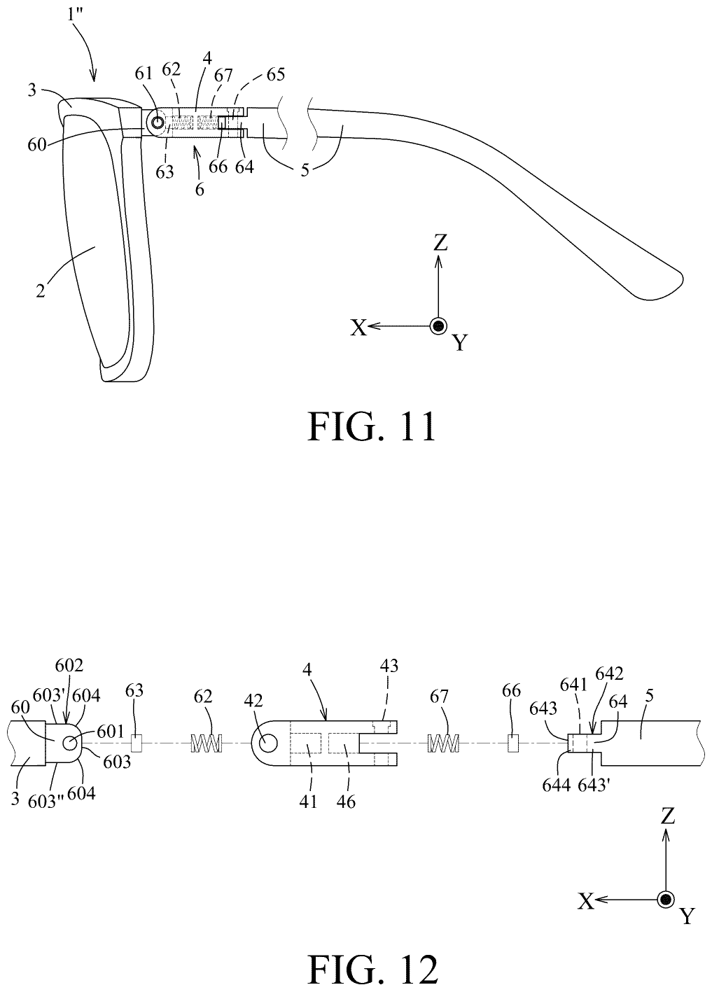

Referring to FIGS. 10 to 12, the third embodiment of the eyeglass frame 1″ of the eyeglasses 100″ of this disclosure is shown to be substantially identical to the first embodiment, and differs from the first embodiment in the structures of the temple-connecting arms and the hinge assembly 6. In this embodiment, the second groove 46 of each temple-connecting arm 4 is deeper than that of the first embodiment, and the hinge assembly 6 further includes two second pressing members 66 and two second biasing members 67.

Furthermore, in this embodiment, the second seat body 642 of each second shaft seat 64 has three planar second positioning surfaces 643, 643′, 643″ respectively located at front, left and right sides thereof (the second positioning surface 643″ located at the right side thereof is not visible in FIG. 12), and two curved second sliding surfaces 644 (only one is visible in FIG. 12), each connected between two adjacent ones of the second positioning surfaces 643, 643′, 643″. The structure and function of the second seat body 642, the second positioning surfaces 643, 643′, 643″, and the second sliding surfaces 644 are respectively similar to those of the first seat body 602, the first positioning surfaces 603, 603′, 603″, and the first sliding surfaces 604.

The second biasing members 67 are respectively disposed in the second grooves 46 of the temple-connecting arms 4, and have front ends respectively abutting against the bottoms of the second grooves 46, and rear ends respectively facing the second seat bodies 642 of the second shaft seats 64. In this embodiment, each second biasing member 67 is the same as each first biasing member 62, and is, for example, a compression spring, which can generate an elastic biasing force corresponding to the different amount of deformation.

Each second pressing member 66 is disposed between and abuts against the rear end of one of the second biasing members 67 and the second seat body 642 of a corresponding one of the second shaft seats 64. Each second pressing member 66 is capable of abutting against different surfaces of the second seat body 642 of the corresponding second shaft seat 64 when each temple 5 is rotated relative to the respective temple-connecting arm 4, so that each second biasing member 67 can generate different biasing forces accordingly. In this embodiment, the structure and function of each second pressing member 66 are similar to those of each first pressing member 63.

According to the preceding description, in this embodiment, the eyeglass frame 1″ is configured based on the arrangement of the temple-connecting arms 4, the temples 5, and the hinge assembly 6, so that an actuating mechanism that allows the temple-connecting arms 4 to rotate relative to the lens frame 3 in the up-down direction (Z) and the temples 5 to rotate relative to the respective temple-connecting arms 4 in the left-right direction (Y) can be similarly achieved. Thus, regardless of which direction the eyeglasses 100″ are subjected to external forces, the eyeglass frame 1″ of the eyeglasses 100″ can adaptively change the structural form thereof, thereby preventing the structure of the eyeglasses 100″ from permanent deformation and fracture damage. Moreover, through the dispositions of the first seat bodies 602 of the first shaft seats 60, the the first pressing members 63, the second pressing members 66, and the second biasing members 67, the temple-connecting arms 4 can be structurally positioned at different up and down rotational positions relative to the lens frame 3 or automatically restored to a position in which the rear ends thereof face rearward under the biasing forces of the first biasing members 62, and the temples 5 can be structurally positioned at different left and right rotational positions relative to the respective temple-connecting arms 4 or automatically restored to a position in which the rear ends thereof face rearward under the biasing forces of the second biasing members 67 so as to meet the various usage requirements of the user.

### First Alternative Form of the Third Embodiment

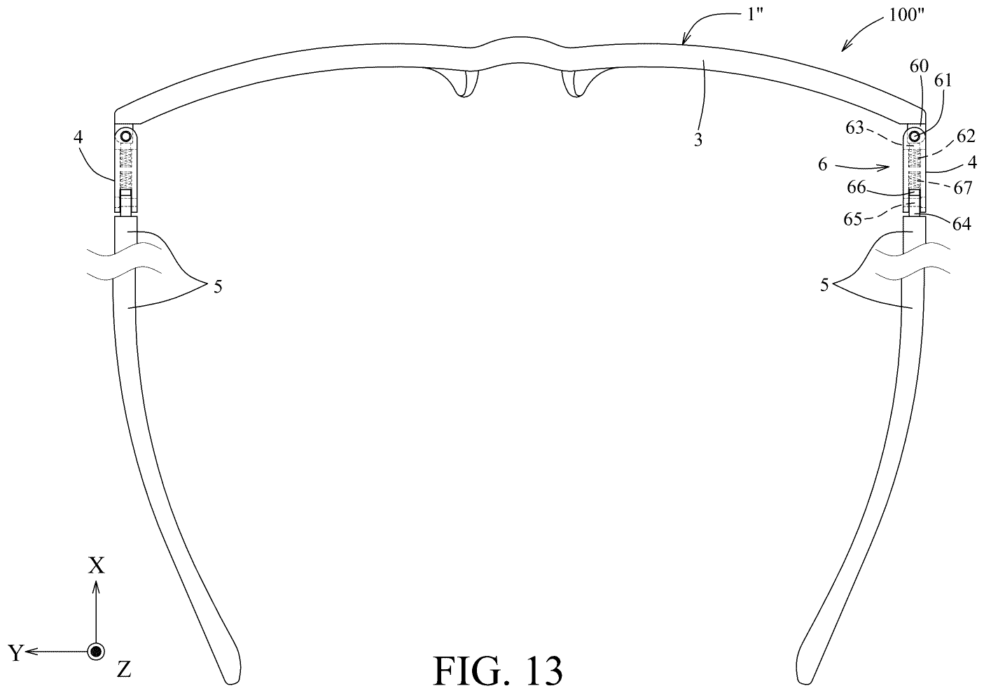

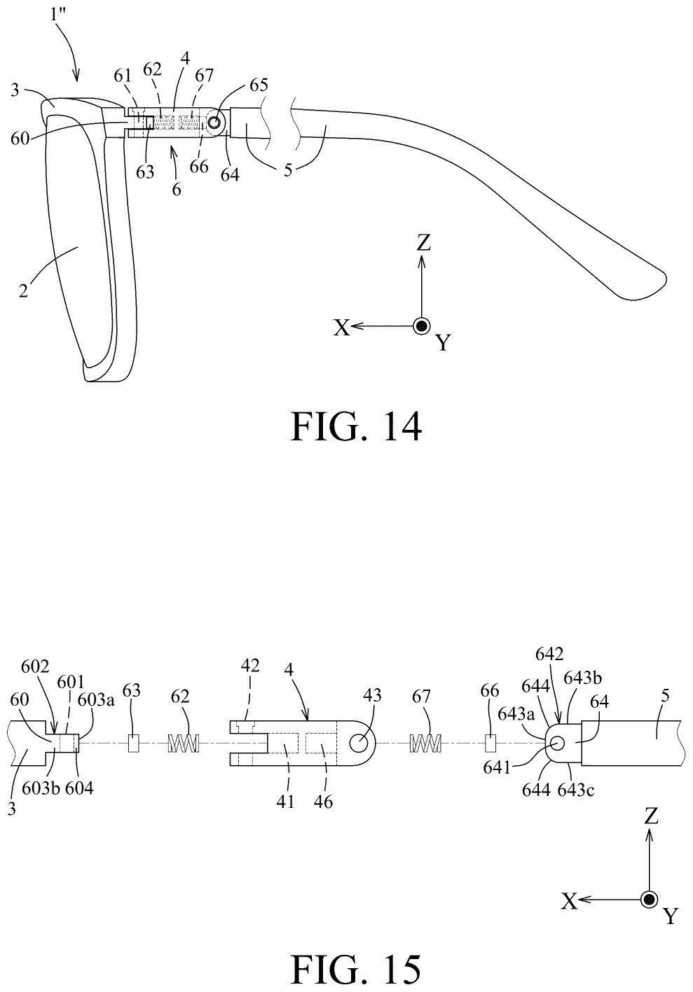

FIGS. 13 to 15 illustrate a first alternative form of the third embodiment. In this case, the structures of the first and second shaft seats 60, 64 are interchanged such that the temple-connecting arms 4 are rotatable relative to the lens frame 3 in the left-right direction (Y), and the temples 5 are rotatable relative to the respective temple-connecting arms 4 in the up-down direction (Z). Correspondingly, each first shaft pin 61 extends in the up-down direction (Z), and each second shaft pin 65 extends in the left-right direction (Y). Furthermore, the first seat body 602 of each first shaft seat 60 has three planar first positioning surfaces (603a, 603b, 603c) respectively located at rear, left and right sides thereof (the first positioning surface 603c located at the right side thereof is not visible in FIG. 15), and two curved first sliding surfaces 604 each connected between two adjacent first positioning surfaces (603a, 603b, 603c). The second seat body 642 of each second shaft seat 64 has three planar second positioning surfaces (643a, 643b, 643c) respectively located at front, top and bottom sides thereof, and two curved second sliding surfaces 644 each connected between two adjacent second positioning surfaces (643a, 643b, 643c).

In this first alternative form of the third embodiment, although the rotatable directions of each temple-connecting arm 4 and each temple 5 of the eyeglass frame 1″ are different from those of the third embodiment, when the eyeglasses 100″ are subjected to external forces from the front-rear direction (X), the left-right direction (Y), and the up-down direction (Z), the eyeglass frame 1″ of the eyeglasses 100″ can adaptively change the structural form thereof under the action of left and right rotation of the temple-connecting arms 4 and/or up and down rotation of the temples 5, so that permanent deformation and fracture damage of the structure of the eyeglasses 100″ can be similarly prevented. Moreover, the temple-connecting arms 4 can be similarly structurally positioned at different left and right positions relative to the lens frame 3 or automatically restored to a position in which the rear ends thereof face rearward under the biasing forces of the first biasing members 62, and the temples 5 can be similarly structurally positioned at different up and down rotational positions relative to the temple-connecting arms 4 or automatically restored to a position in which the rear ends thereof face rearward under the biasing forces of the second biasing members 67 so as to meet the various usage requirements of the user.

### Second Alternative Form of the Third Embodiment

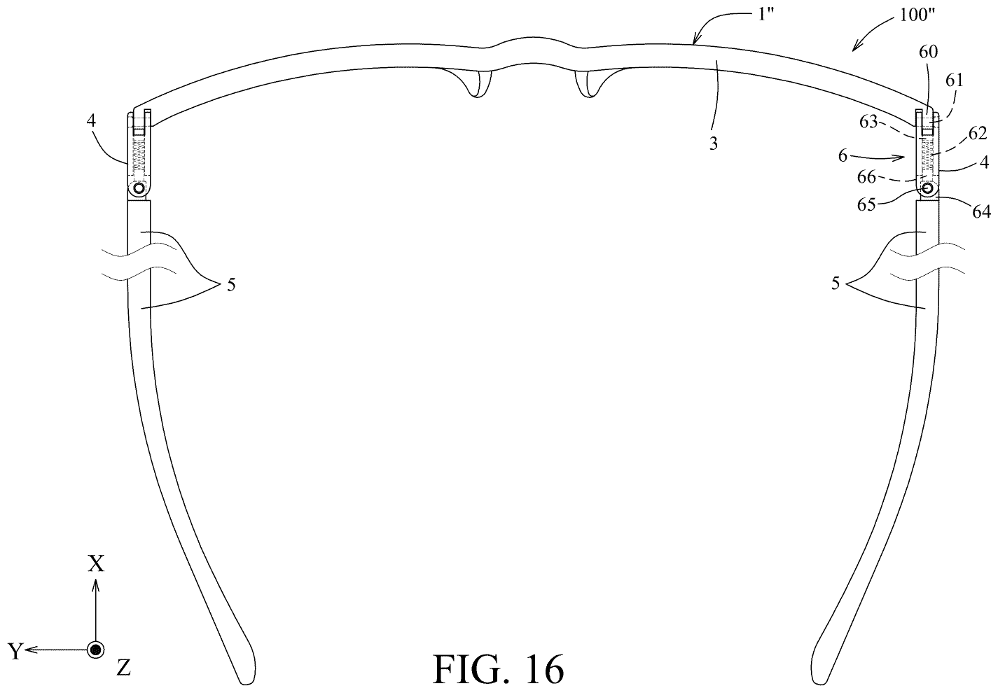

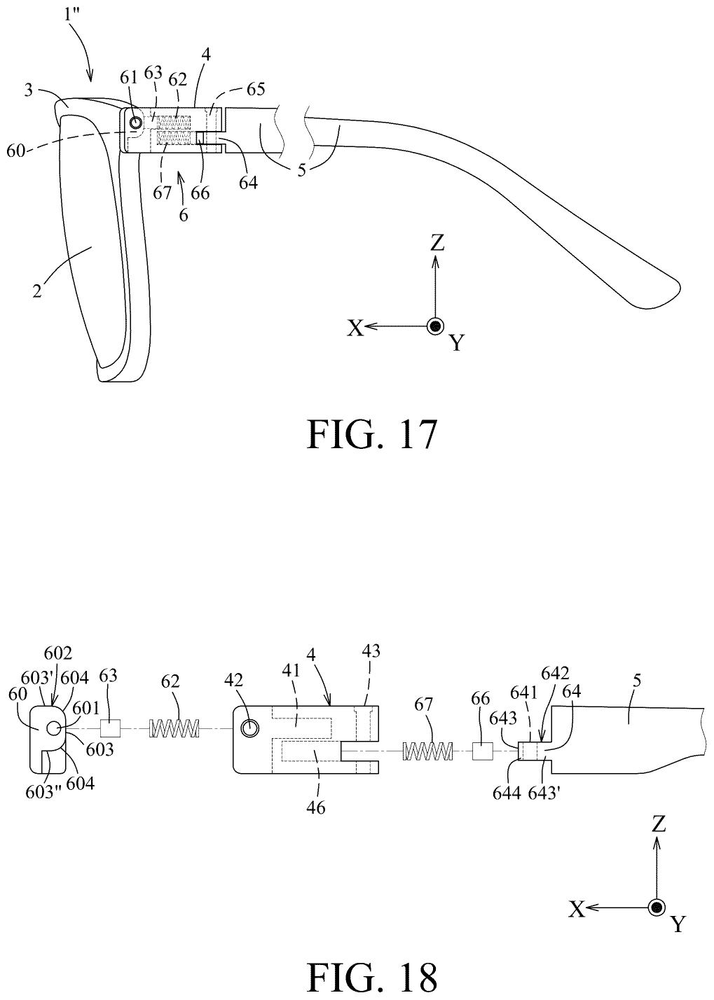

FIGS. 16 to 18 show a second alternative form of the third embodiment. In this case, the first and second grooves 41, 46 of each temple-connecting arm 4 do not extend along the same straight line, and are located one above the other. Specifically, the first groove 41 of each temple-connecting arm 4 is located on top of the second groove 46 thereof. Thus, each first biasing member 62 is disposed in the first groove 41 of the respective temple-connecting arm 4, and each second biasing member 67 is disposed in the second groove 46 of the respective temple-connecting arm 4.

According to the structural configuration of the second alternative form of the third embodiment, the eyeglass frame 1″ of the eyeglasses 100″ can similarly achieve an actuating mechanism similar to that described in the third embodiment which can allow the temple-connecting arms 4 to rotate relative to the lens frame 3 in the up-down direction (Z) and the temples 5 to rotate relative to the respective temple-connecting arms 4 in the left-right direction (Y). Thus, regardless of which direction the eyeglasses 100″ are subjected to external forces, the eyeglass frame 1″ of the eyeglasses 100″ can adaptively change the structural form thereof, thereby preventing the structure of the eyeglasses 100″ from permanent deformation and fracture damage. Moreover, through the dispositions of the first seat bodies 602 of the first shaft seats 60, the second seat bodies 642 of the second shaft seats 64, the first biasing members 62, the first pressing members 63, the second pressing members 66, and the second biasing members 67, although the dispositions of the first and second biasing members 62, 67 are different from those of the third embodiment, the temple-connecting arms 4 can be similarly structurally positioned at different up-down rotational positions relative to the lens frame 3 or automatically restored to a position in which the rear ends thereof face rearward under the biasing forces of the first biasing members 62, and the temples 5 can be similarly structurally positioned at different left and right rotational positions relative to the respective temple-connecting arms 4 or automatically restored to a position in which the rear ends thereof face rearward under the biasing forces of the second biasing members 67 so as to meet the various usage requirements of the user.

### Third Alternative Form of the Third Embodiment

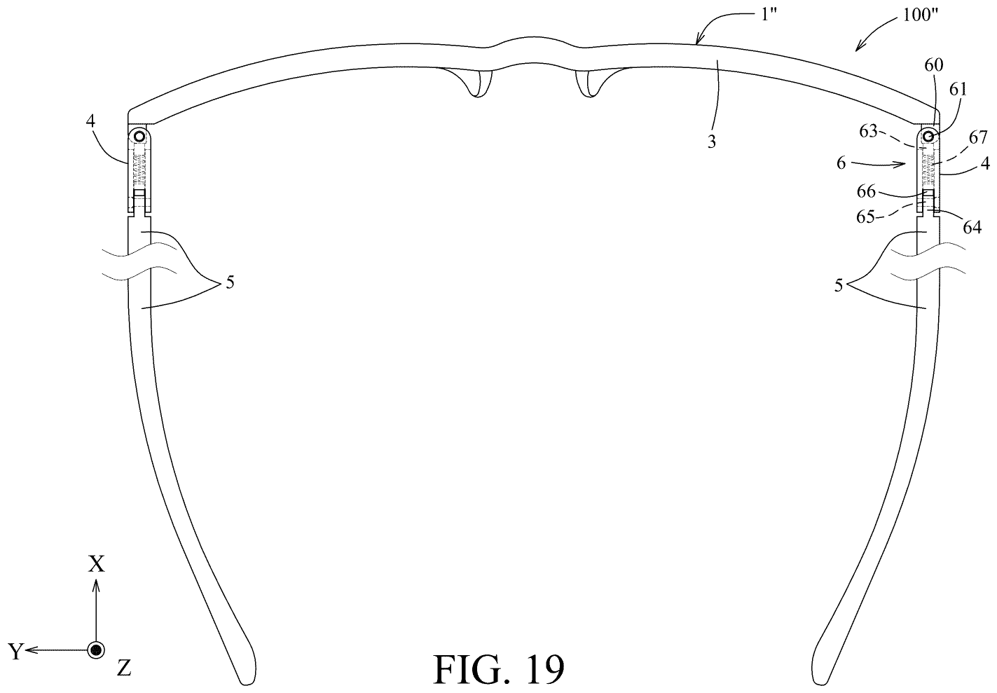

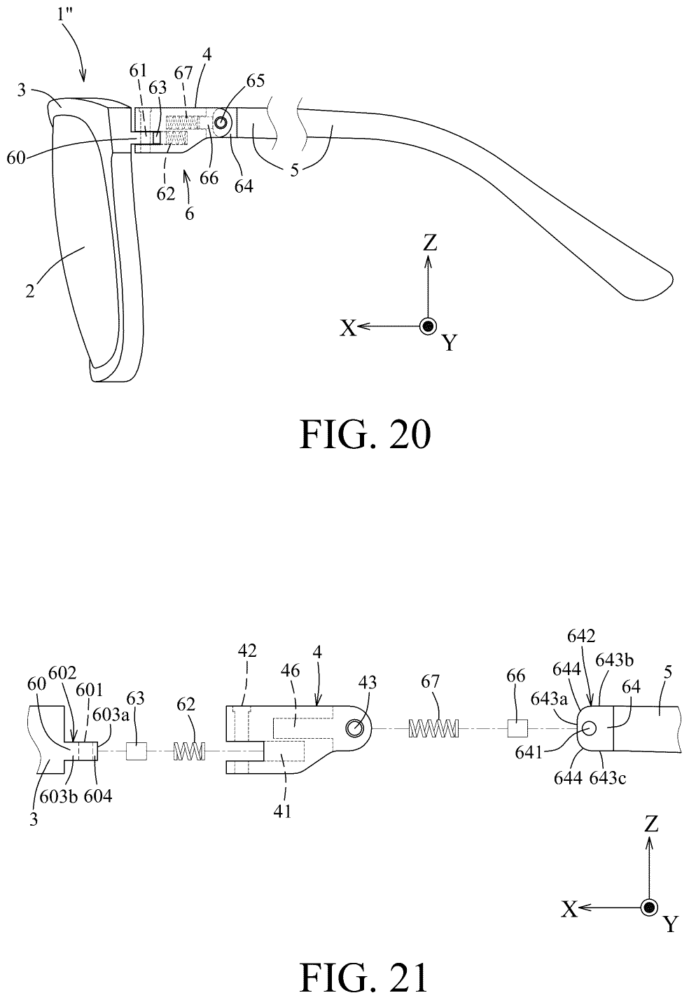

Referring to FIGS. 19 to 21, a third alternative form of the third embodiment is show to be substantially identical to the first alternative form of the third embodiment shown in FIGS. 13 to 15, and differs from the first alternative form in that the first and second grooves 41, 46 of each temple-connecting arm 4 do not extend along the same straight line, and are located one above the other. Specifically, the first groove 41 of each temple-connecting arm 4 is located below the second groove 46 thereof. Thus, each first biasing member 62 is disposed in the first groove 41 of the respective temple-connecting arm 4, and each second biasing member 67 is disposed in the second groove 46 of the respective temple-connecting arm 4.

According to the structural configuration of the third alternative form of the third embodiment, the eyeglass frame 1″ of the eyeglasses 100″ can similarly achieve an actuating mechanism similar to that described in the first alternative form of the third embodiment which can allow the temple-connecting arms 4 to rotate relative to the lens frame 3 in the left-right direction (Y) and the temples 5 to rotate relative to the respective temple-connecting arms 4 in the up-down direction (Z), so that the eyeglass frame 1 of the eyeglasses 100″ can adaptively change the structural form thereof regardless of which direction the eyeglasses 100″ are subjected to external forces, thereby preventing the structure of the eyeglasses 100″ from permanent deformation and fracture damage. Moreover, through the dispositions of the first seat bodies 602 of the first shaft seats 60, the second seat bodies 642 of the second shaft seats 64, the first biasing members 62, the first pressing members 63, the second pressing members 66, and the second biasing members 67, although the dispositions of the first and second biasing members 62, 67 are different from those of the first alternative form of the third embodiment, the temple-connecting arms 4 can be similarly structurally positioned at different left and right rotational positions relative to the lens frame 3 or automatically restored to a position in which the rear ends thereof face rearward under the biasing forces of the first biasing members 62, and the temples 5 can be similarly structurally positioned at different up and down rotational positions relative to the respective temple-connecting arms 4 or automatically restored to a position in which the rear ends thereof face rearward under the biasing forces of the second biasing members 67 so as to meet the various usage requirements of the user.

### Fourth Embodiment

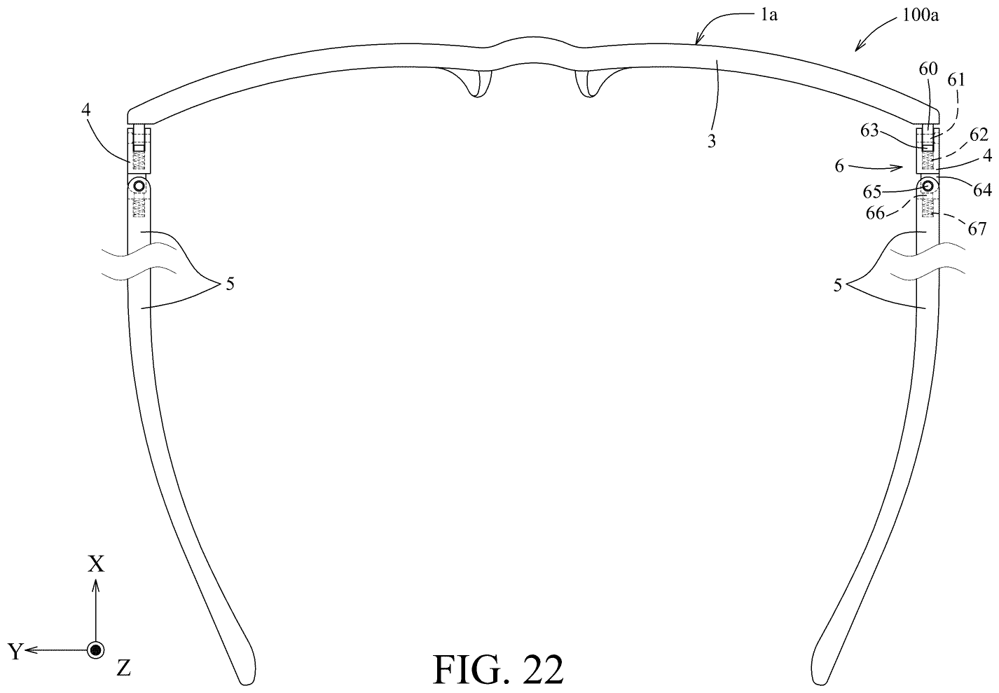

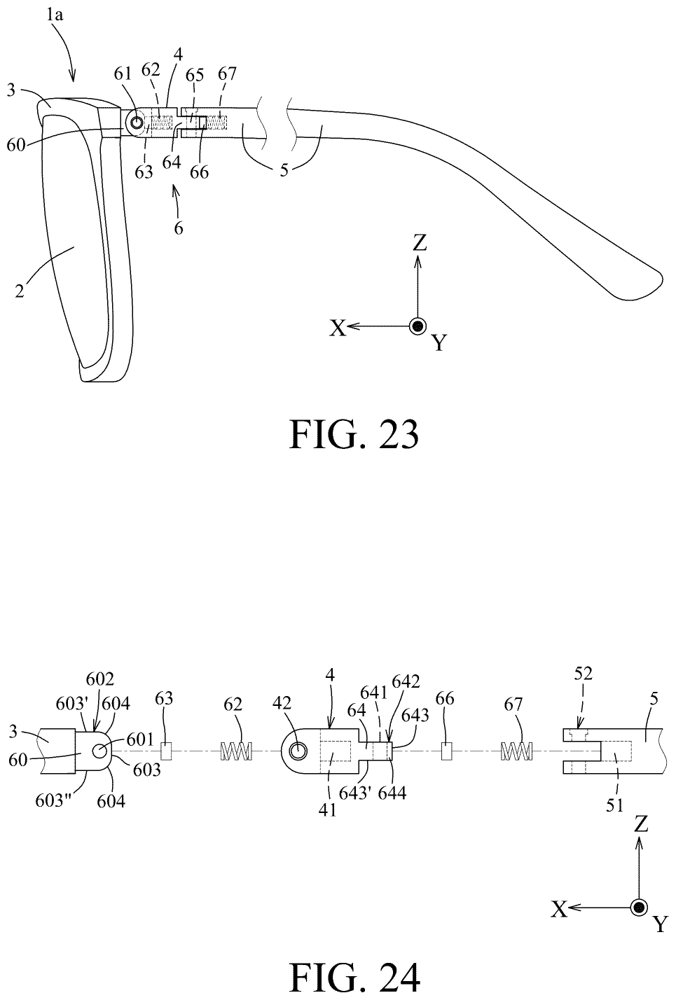

Referring to FIGS. 22 to 24, the fourth embodiment of the eyeglass frame (1a) of the eyeglasses (100a) of this disclosure is shown to be substantially identical to the first embodiment, and differs from the first embodiment in the structures of the temple-connecting arms 4, the temples 5, and the hinge assembly 6. In this embodiment, each temple-connecting arm 4 does not include the second groove 46 (see FIG. 3) and only include the first groove 41 and the first shaft hole 42, and each temple 5 has an accommodating groove 51 extending inwardly from a front end thereof, and a shaft hole 52 formed in the front end and communicating transversely with the accommodating groove 51. Furthermore, the temple-connecting arms 4 are rotatable relative to the lens frame 3 in the up-down direction (Z), and the temples 5 are rotatable relative to the respective temple-connecting arms 4 in the left-right direction (Y), so that whether the eyeglasses (100a) are subjected to external forces from the front-rear direction (X), the left-right direction (Y), and the up-down direction (Z), the eyeglass frame (1a) of the eyeglasses (100a) can produce corresponding structural changes through rotations of the temple-connecting arms 4 and/or the temples 5, and the eyeglasses (100a) can adapt to external forces to the greatest extent so as to prevent permanent deformation and fracture damage to the structure thereof.

Moreover, in this embodiment, the hinge assembly 6 further includes two second pressing members 66 and two second biasing members 67. The second shaft seats 64 of the hinge assembly 6 are respectively disposed on the rear ends of the temple-connecting arms 4. Each second shaft seat 64 has a second seat body 642 protruding from the rear end of the respective temple-connecting arm 4 and inserted into the accommodating groove 51 of a respective one of the temples and having a non-arcuate shape, and a second seat hole 641 formed in the second seat body 642 and aligned with the shaft hole 52 of the respective temple 5. Specifically, in this embodiment, the second seat body 642 has three planar second positioning surfaces 643, 643′, 643″ respectively located at rear, left and right sides thereof (the second positioning surface 643″ located at the right side thereof is not visible in FIG. 24), and two curved second sliding surfaces 644 (only one is visible in FIG. 24) each connected between two adjacent ones of the second positioning surfaces 643, 643′, 643″. The structure and function of the second seat body 642, the second positioning surfaces 643, 643′, 643″, and the second sliding surfaces 644 are respectively similar to those of the first seat body 602, the first positioning surfaces 603, 603′, 603″, and the first sliding surfaces 604.

Each second shaft pin 65 is inserted into the shaft hole 52 of the respective temple 5 and the aligned second seat hole 641. An extending direction of each second shaft pin 65 is different from that of each first shaft pin 61. In this embodiment, each second shaft pin 65 extends in the up-down direction (Z). As such, each second shaft pin 65 can serve as a rotation axis for each temple 5 to rotate relative to the respective temple-connecting arm 4 in the left-right direction (Y). The second biasing members 67 are respectively disposed in the accommodating grooves 51 of the temples 5, and have front ends respectively facing the second seat bodies 642 of the second shaft seats 64, and rear ends respectively abutting against the bottoms of the accommodating grooves 51. In this embodiment, each second biasing member 67 is, for example, a compression spring which can generate an elastic biasing force according to the different amount of deformation. Each second pressing member 66 is disposed between and abuts against the front end of one of the second biasing members 67 and the second seat body 642 of a corresponding one of the second shaft seats 64. Each second pressing member 66 is capable of abutting against different surfaces of the second seat body 642 of the corresponding second shaft seat 64 when each temple is rotated relative to the respective temple-connecting arm 4, so that each second biasing member 67 can generate different biasing forces according to different abutment positions of each second pressing member 66. The structure and function of each second pressing member 66 are similar to those of each first pressing member 63.

According to the preceding description, in the fourth embodiment, the eyeglass frame (1a) is configured based on the arrangement of the temple-connecting arms 4, the temples 5, and the hinge assembly 6, so that an actuating mechanism that allows the temple-connecting arms 4 to rotate relative to the lens frame 3 in the up-down direction (Z) and the temples 5 to rotate relative to the respective temple-connecting arms 4 in the left-right direction (Y) can be similarly achieved. Thus, the eyeglass frame (1a) of the eyeglasses (100a) can adaptively change the structural form thereof regardless of which direction the eyeglasses (100a) are subjected to external forces so as to prevent the structure of the eyeglasses (100a) from permanent deformation and fracture damage. Moreover, through the dispositions of the first seat bodies 602 of the first shaft seats 60, the the first pressing members 63, the second pressing members 66, and the second biasing members 67, the temple-connecting arms 4 can be similarly structurally positioned at different up and down rotational positions relative to the lens frame 3 or automatically restored to a position in which the rear ends thereof face rearward under the biasing forces of the first biasing members 62, and the temples 5 can be similarly structurally positioned at different left and right rotational positions relative to the temple-connecting arms 4 or automatically restored to a position in which the rear ends thereof face rearward under the biasing forces of the second biasing members 67 so as to meet the various usage requirements of the user.

### Alternative Form of the Fourth Embodiment

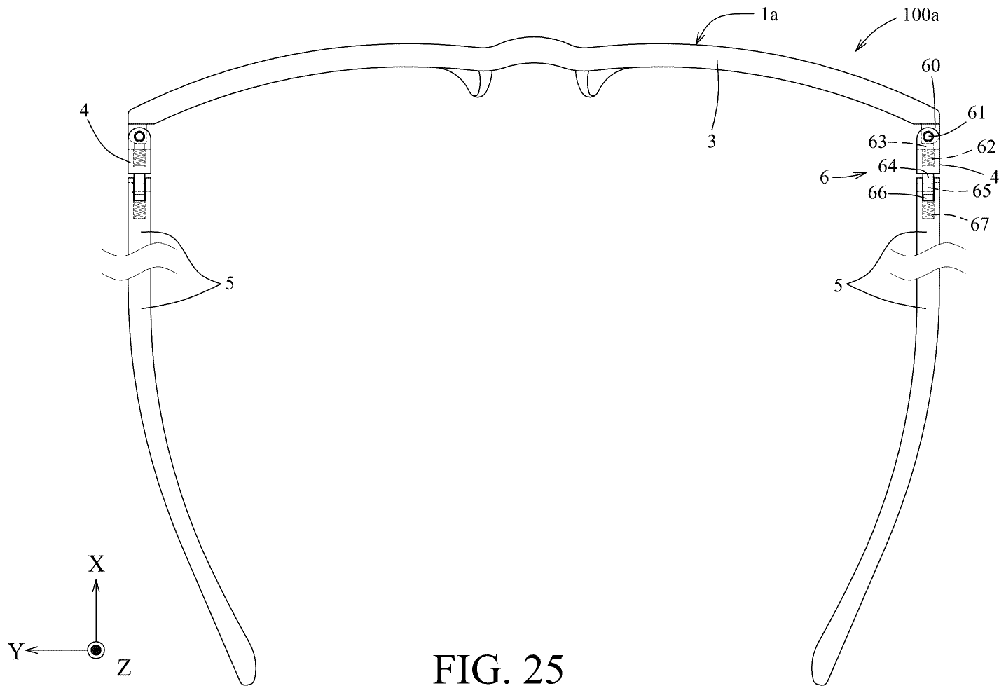

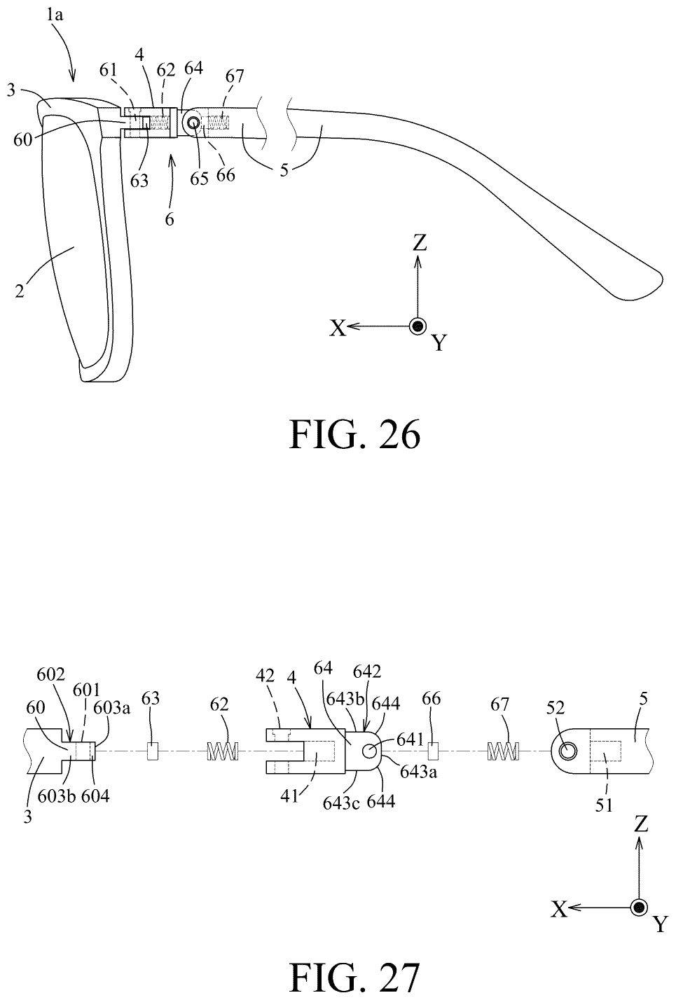

FIGS. 25 to 27 illustrate an alternative form of the fourth embodiment. In this case, the structures of the first and second shaft seats 60, 64 are interchanged such that the temple-connecting arms 4 are rotatable relative to the lens frame 3 in the left-right direction (Y), and the temples 5 are rotatable relative to the respective temple-connecting arms 4 in the up-down direction (Z). Correspondingly, each first shaft pin 61 extends in the up-down direction (Z), and each second shaft pin 65 extends in the left-right direction (Y). Furthermore, the first seat body 602 has three planar first positioning surfaces (603a, 603b, 603c) respectively located at rear, left and right sides thereof (the first positioning surface 603c located at the right side thereof is not visible in FIG. 27), and two curved first sliding surfaces 604 (only one is visible in FIG. 27) each connected between two adjacent ones of the first positioning surfaces (603a, 603b, 603c). The second seat body 642 has three planar second positioning surfaces (643a, 643b, 643c) respectively located at rear, top and bottom sides thereof, and two curved second sliding surfaces 644 each connected between two adjacent second positioning surfaces (643a, 643b, 643c).

In this alternative form of the fourth embodiment, although the rotatable directions of each temple-connecting arm 4 and each temple 5 of the eyeglass frame (1a) of the eyeglasses (100a) are different from those of the fourth embodiment, when the eyeglasses (100a) are subjected to external forces from the front-rear direction (X), the left-right direction (Y), and the up-down direction (Z), the eyeglass frame (1a) of the eyeglasses (100a) can adaptively change the structural form thereof under the action of left and right rotation of the temple-connecting arms 4 and/or up and down rotation of the temples 5, so that permanent deformation and fracture damage of the structure of the eyeglasses (100a) can be similarly prevented. Moreover, through the dispositions of the first seat bodies 602 of the first shaft seats 60, the second seat bodies 642 of the second shaft seats 64, the first biasing members 62, the first pressing members 63, the second pressing members 66, and the second biasing members 67, the temple-connecting arms 4 can be structurally positioned at different left and right rotational positions relative to the lens frame 3 or automatically restored to a position in which the rear ends thereof face rearward under the biasing forces of the first biasing members 62, and the temples 5 can be structurally positioned at different up and down rotational positions relative to the respective temple-connecting arms 4 or automatically restored to a position in which the rear ends thereof face rearward under the biasing forces of the second biasing members 67 so as to meet the various usage requirements of the user.

### Fifth Embodiment

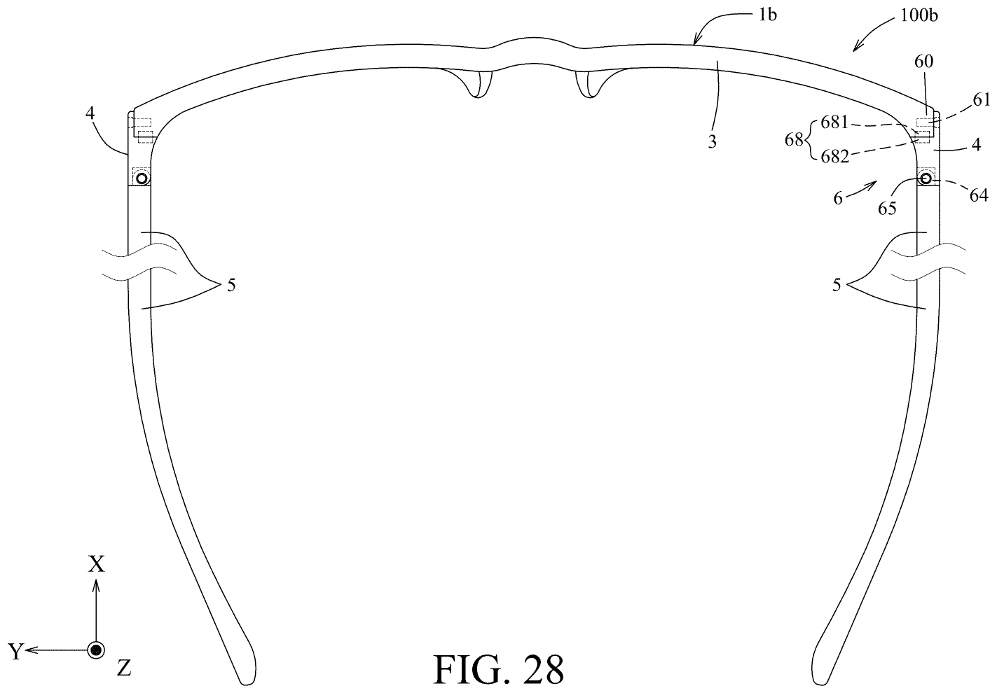

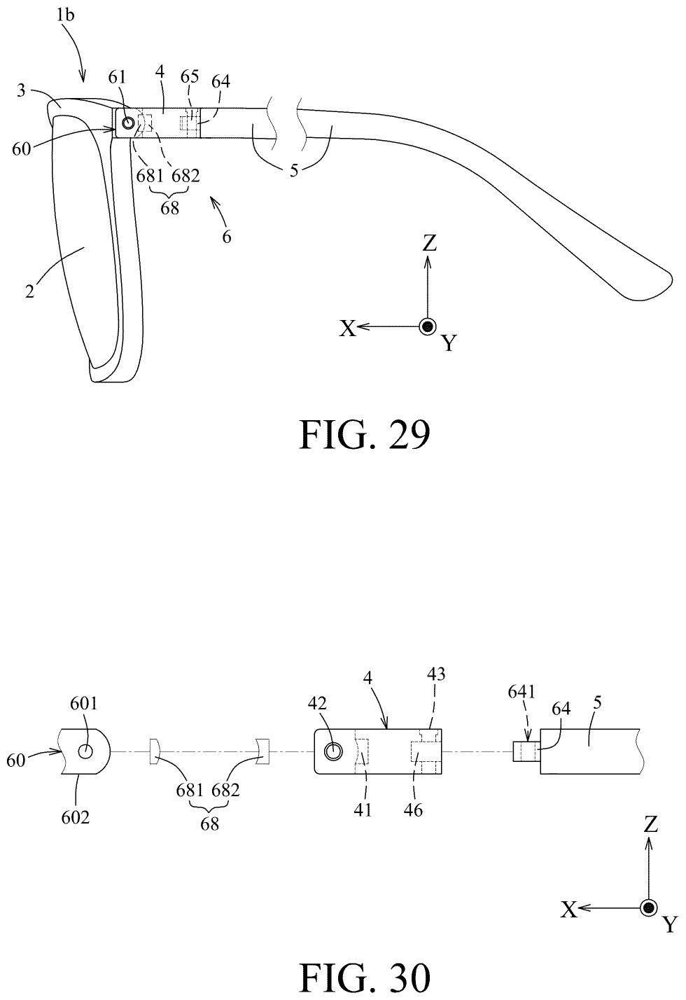

Referring to FIGS. 28 to 30, the fifth embodiment of the eyeglass frame (1b) of the eyeglasses (100b) of this disclosure is shown to be substantially identical to the first embodiment, and differs from the first embodiment in the structures of the temple-connecting arms 4 and the hinge assembly 6. In this embodiment, the front end of each temple-connecting arm 4 has a substantially rectangular shape, and the hinge assembly 6 does not include the two first biasing members 62 (see FIG. 3) and the two first pressing members 63 (see FIG. 3), but further includes two magnetic positioning units 68. Each magnetic positioning unit 68 includes a first magnetic member 681 and a second magnetic member 682 magnetically attracted to each other. Furthermore, the first biasing members 62 and the first pressing members 63 are dispensed herewith.

In this embodiment, the first seat body 602 of each first shaft seat 60 and the front end of the respective temple-connecting arm 4 are fixed to a corresponding one of the left and right sides of the lens frame 3 by inserting each first shaft pin 61 into the first seat hole 602 of the first seat body 602 of the respective first shaft seat 60 and the aligned first shaft hole 42 and fixed to the corresponding left or right side of the lens frame 3. Through this, each temple-connecting arm 4 is similarly rotatable relative to the lens frame 3 in the up-down direction (Z). The first magnetic members 681 of the magnetic positioning units 68 are respectively disposed in the rear ends of the first seat bodies 602 of the first shaft seats 60. The second magnetic members 682 of the magnetic positioning units 68 are respectively disposed in the first grooves 41 of the temple-connecting arms 4. The first and second magnetic members 681, 682 of each magnetic positioning unit 68 are magnetically attracted to each other when each temple-connecting arm 4 is rotated relative to the lens frame 3 to a predetermined position. The predetermined position of each temple-connecting arm 4 is a position in which the rear end of each temple-connecting arm 4 faces rearward. Specifically, in the fifth embodiment, because the first magnetic members 681 are respectively disposed in the rear ends of the first seat bodies 602 of the first shaft seats 60, when each temple-connecting arm 4 is rotated relative to the lens frame 3 to the predetermined position, the first and second magnetic members 681, 682 of each magnetic positioning unit 68 are adjacent to each other in the front-rear direction (X) and are magnetically attracted to each other. As such, each temple-connecting arm 4 can be maintained at a state in which the rear end thereof faces rearward relative to the lens frame 3 through magnetic attraction between the first and second magnetic members 681, 682 so as to meet the conventional wearing requirement of the user.

According to the preceding description, in the fifth embodiment, the eyeglass frame (1b) is configured based on the arrangement of the temple-connecting arms 4, the temples 5, and the hinge assembly 6, so that an actuating mechanism that allows the temple-connecting arms 4 to rotate relative to the lens frame 3 in the up-down direction (Z) and the temples 5 to rotate relative to the respective temple-connecting arms 4 in the left-right direction (Y) can be achieved. Thus, regardless of which direction the eyeglasses (100b) are subjected to external forces, the eyeglass frame (1b) of the eyeglasses (100b) can adaptively change the structural form thereof, thereby preventing permanent deformation and fracture damage of the structure of the eyeglasses (100b). Moreover, through the dispositions of the first and second magnetic members 681, 682 of the magnetic positioning units 68, the temple-connecting arms 4 can be maintained at a state in which the rear ends thereof face rearward relative to the lens frame 3 so as to meet the conventional wearing requirement of the user. It should be noted that each magnetic positioning unit 68 may include other magnetic members apart from the first and second magnetic members 681, 682 so as to position each temple-connecting arm 4 at different states relative to the lens frame 3, thereby providing the user with different ways of using the eyeglasses (100b).

### Alternative Form of the Fifth Embodiment

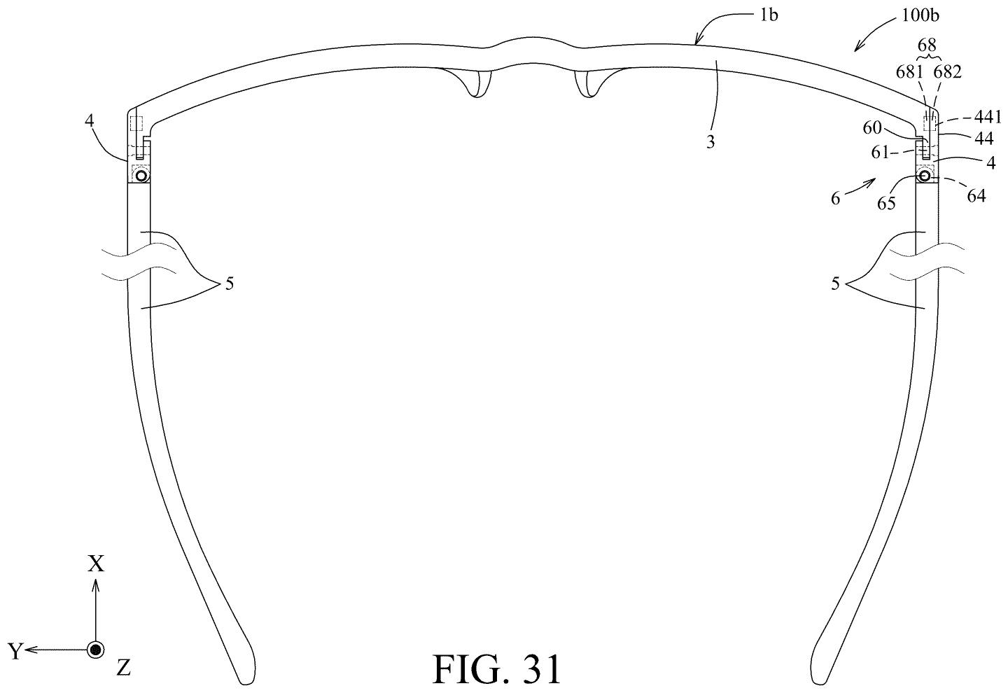

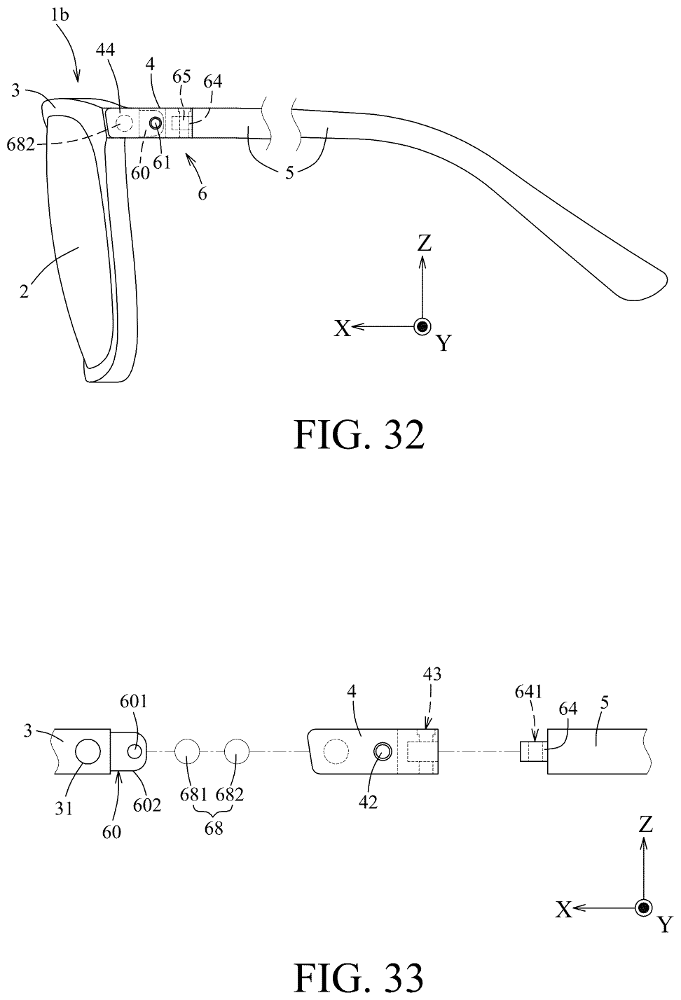

FIGS. 31 to 33 illustrate an alternative form of the fifth embodiment. In this case, each of the left and right sides of the lens frame 3 is formed with a groove 31; each temple-connecting arm 4 further includes an extension section 44 extending forwardly from the front end thereof and formed with a groove 441 that is aligned with the groove 31 of a respective one of the left and right sides of the lens frame 3 in the left-right direction (Y); the first magnetic members 681 of the magnetic positioning units 68 are respectively disposed in the grooves 31 of the left and right sides of the lens frame 3, and the second magnetic members 682 of the magnetic positioning units 68 are respectively disposed in the grooves 441 of the extension sections 44 of the temple-connecting arms 4. Thus, when each temple-connecting arm 4 is rotated relative to the lens frame 3 to the predetermined position, the extension section 44 of each temple-connecting arm 4 will overlap with the respective left or right side of the lens frame 3, so that the first and second magnetic members 681, 682 of each magnetic positioning unit 68 are magnetically attracted to each other. As such, each temple-connecting arm 4 can be maintained in a state in which the rear end thereof faces rearward relative to the lens frame 3 through magnetic attraction of the first and second magnetic members 681, 682 of each magnetic positioning unit 68 so as to meet the conventional wearing requirement of the user.

According to the preceding description, in the alternative form of the fifth embodiment, the eyeglass frame (1b) is similarly configured based on the arrangement of the temple-connecting arms 4, the temples 5, and the hinge assembly 6, so that an actuating mechanism that allows the temple-connecting arms 4 to rotate relative to the lens frame 3 in the up-down direction (Z) and the temples 5 to rotate relative to the respective temple-connecting arms 4 in the left-right direction (Y) can be achieved. Thus, regardless of which direction the eyeglasses (100b) are subjected to external forces, the eyeglass frame (1b) of the eyeglasses (100b) can adaptively change the structural form thereof, so as to prevent permanent deformation and fracture damage of the structure of the eyeglasses (100b). Moreover, although the disposition of the first and second magnetic members 681, 682 is different from that of the fifth embodiment, and the shape of each temple-connecting arm 4 is slightly different from that of the fifth embodiment, the magnetic attraction between the first and second magnetic members 681, 682 of each magnetic positioning unit 68 can be similarly used to maintain each temple-connecting arm 4 at the predetermined position in which the rear end thereof faces rearward relative to the lens frame 3 so as to meet the various usage requirements of the user.

### Sixth Embodiment

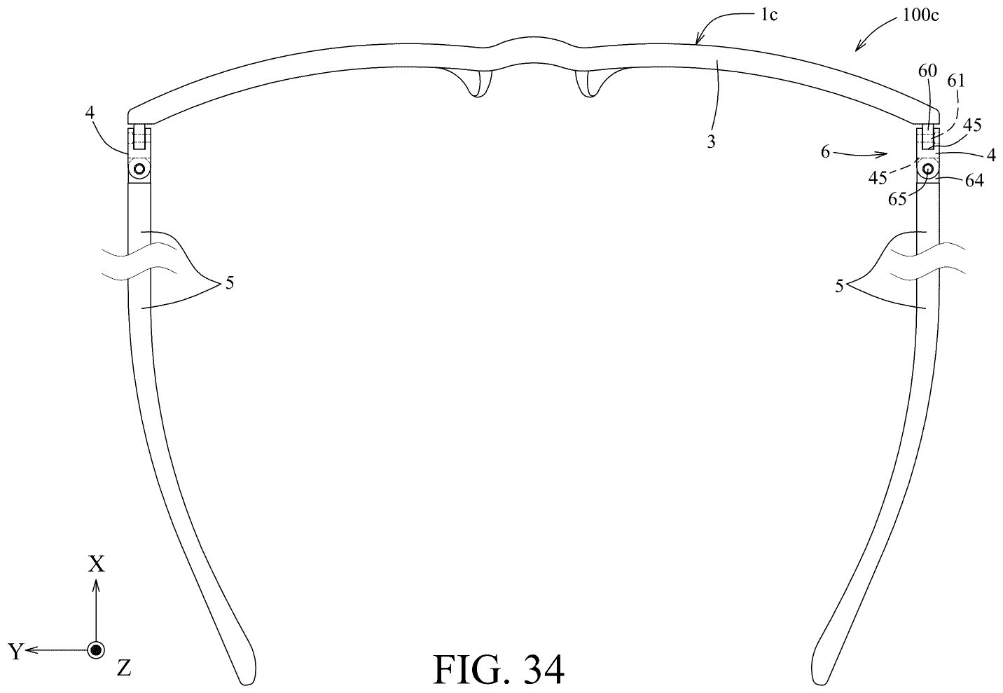

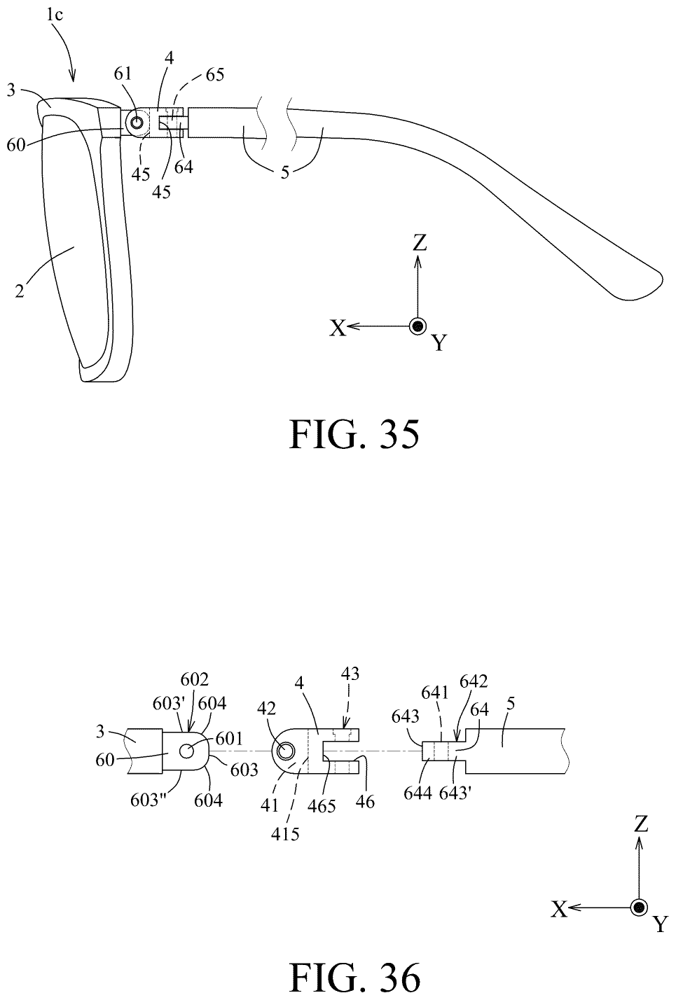

Referring to FIGS. 34 to 36, the sixth embodiment of the eyeglass frame (1c) of the eyeglasses (100c) of this disclosure is shown to be substantially similar to the first embodiment, and differs from the first embodiment in the structures of the temple-connecting arms 4 and the hinge assembly 6. In this embodiment, each temple-connecting arm 4 is configured to be shorter than that of the first embodiment in the front-rear direction (X), but slightly wider than that of the first embodiment in the up-down direction (Z); and the hinge assembly 6 does not include the two first biasing members 62 (see FIG. 3) and the two first pressing members 63 (see FIG. 3). That is, in this embodiment, the hinge assembly 6 includes the two first shaft seats 60, the two first shaft pins 61, the two second shaft seats 64, and the two second shaft pins 65.

With reference to FIG. 36, when the rear first positioning surface 603 of the first seat body 602 abuts against the bottom 415 of the first groove 41, a fixing effect of the temple-connecting arm 4 can be achieved due to the structural interference between the rear first positioning surface 603 of the first seat body 602 and the bottom 415 of the first groove 41, so that the temple-connecting arm 4 will not rotate relative to the lens frame 3 when no further external force is applied thereto. On the other hand, when one of the first sliding surfaces 604 of the first seat body 602 abuts against the bottom 415 of the first groove 41, based on the curved configuration of each first sliding surface 604, the temple-connecting arm 4 can be easily rotated relative to the lens frame 3 so as to facilitate adjustment of the state of the temple-connecting arm 4 by the user.

In this embodiment, the second seat body 642 of each second shaft seat 64 has three planar second positioning surfaces 643, 643′, 643″ respectively located at front, left and right sides thereof (the second positioning surface 643″ located at the right side thereof is not visible in FIG. 36), and two curved second sliding surfaces 644 (only one is visible in FIG. 36) each connected between two adjacent ones of the second positioning surfaces 643, 643′, 643″. The structure and function of the second seat body 642, the second positioning surfaces 643, 643′, 643″, and the second sliding surfaces 644 are respectively similar to those of the first seat body 602, the first positioning surfaces 603, 603′, 603″, and the first sliding surfaces 604. When the front second positioning surface 643 of the second seat body 642 abuts against the bottom 465 of the second groove 46, through structural interference between the front second positioning surface 643 and the bottom 465 of the second groove 46, a fixing effect that prevents each temple 5 to rotate relative to the respective temple-connecting arm 4 can be achieved when no external force is applied thereto. Moreover, through the curved configuration of each second sliding surface 644 of the second seat body 642, each temple 5 can be easily rotated relative to the respective temple-connecting arm 4 so as to facilitate adjustment of the state of each temple 5 by the user.

According to the preceding description, in the sixth embodiment, the eyeglass frame (1c) is similarly configured based on the arrangement of the temple-connecting arms 4, the temples 5, and the hinge assembly 6, so that an actuating mechanism that allows the temple-connecting arms 4 to rotate relative to the lens frame 3 in the up-down direction (Z) and the temples 5 to rotate relative to the respective temple-connecting arms 4 in the left-right direction (Y) can be achieved. Thus, regardless of which direction the eyeglasses (100c) are subjected to external forces, the eyeglass frame (1c) of the eyeglasses (100c) can adaptively change the structural form thereof so as to prevent permanent deformation and fracture damage of the structure of the eyeglasses (100c). Moreover, through the cooperation of the first seat body 602 and the bottom 415 of the first groove 41, each temple-connecting arm 4 can be positioned at different up and down rotational positions relative to the lens frame 3 through the structural interference between the first seat body 602 and the bottom 415 of the first groove 41; and through the cooperation of the second seat body 642 and the bottom 465 of the second groove 46, each temple 5 can be positioned at different left and right rotational positions relative to the respective temple-connecting arm 4 through the structural interference between the second seat body 642 and the bottom 465 of the second groove 46, so as to meet the various usage requirements of the user.

### Alternative Form of the Sixth Embodiment

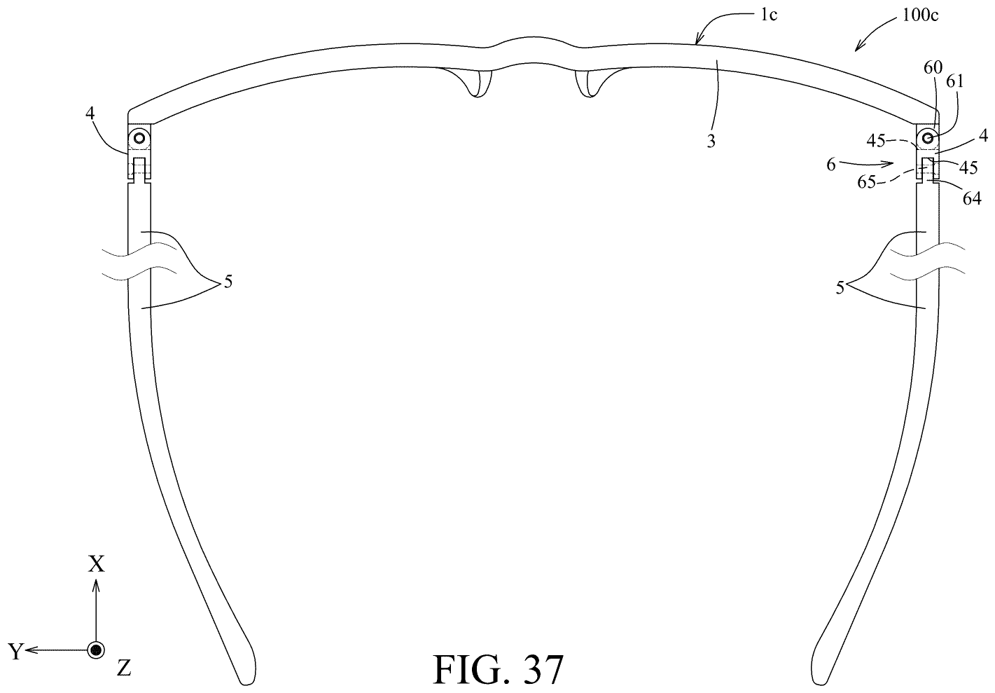

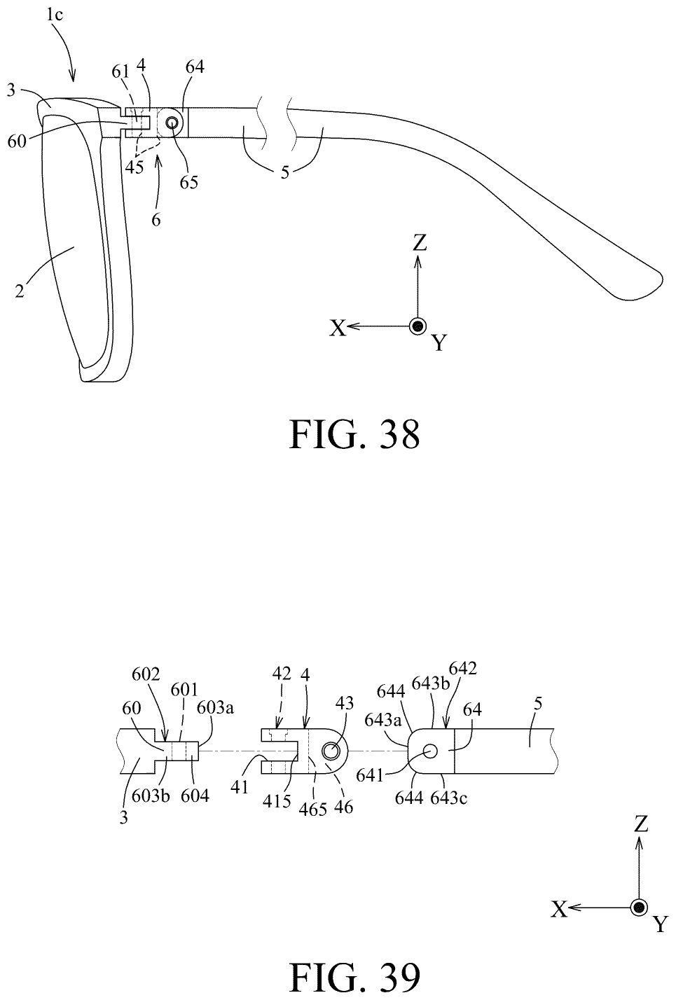

FIGS. 37 to 39 illustrate an alternative form of the sixth embodiment. In this case, the structures of the first and second shaft seats 60, 64 are interchanged such that the temple-connecting arms 4 are rotatable relative to the lens frame 3 in the left-right direction (Y), and the temples 5 are rotatable relative to the respective temple-connecting arms 4 in the up-down direction (Z). Correspondingly, each first shaft pin 61 extends in the up-down direction (Z), and each second shaft pin 65 extends in the left-right direction (Y). Furthermore, the first seat body 602 of each first shaft seat 60 has three planar first positioning surfaces (603a, 603b, 603c) respectively located at rear, left and right sides thereof (the first positioning surface 603c located at the right side thereof is not visible in FIG. 39), and two curved first sliding surfaces 604 (only one is visible in FIG. 39) each connected between two adjacent ones of the first positioning surfaces (603a, 603b, 603c). The second seat body 642 of each second shaft seat 64 has three planar second positioning surfaces (643a, 643b, 643c) respectively located at the front, top and bottom sides thereof, and two curved second sliding surfaces 644 each connected between two adjacent ones of the second positioning surfaces (643a, 643b, 643c).

In this alternative form of the sixth embodiment, although the rotatable directions of each temple-connecting arm 4 and each temple 5 of the eyeglass frame (1c) of the eyeglasses (100c) are different from those of the sixth embodiment, when the eyeglasses (100c) are subjected to external forces from the front-rear direction (X), the left-right direction (Y), and the up-down direction (Z), the eyeglass frame (1c) of the eyeglasses (100c) can adaptively change the structural form thereof under the action of the left and right rotation of the temple-connecting arms 4 and/or the up and down rotation of the temples 5, so that permanent deformation and fracture damage of the structure of the eyeglasses (100c) can be similarly prevented. Moreover, similar to the sixth embodiment, through the cooperation of the first seat body 602 and the bottom 415 of the first groove 41, each temple-connecting arm 4 can be positioned at different left and right rotational positions relative to the lens frame 3 through the structural interference between the first seat body 602 and the bottom 415 of the first groove 41; and through the cooperation of the second seat body 642 and the bottom 465 of the second groove 46, each temple 5 can be positioned at different up and down rotational positions relative to the respective temple-connecting arm 4 through the structural interference between the second seat body 642 and the bottom 465 of the second groove 46, so as to meet the various usage requirements of the user.

### Seventh Embodiment

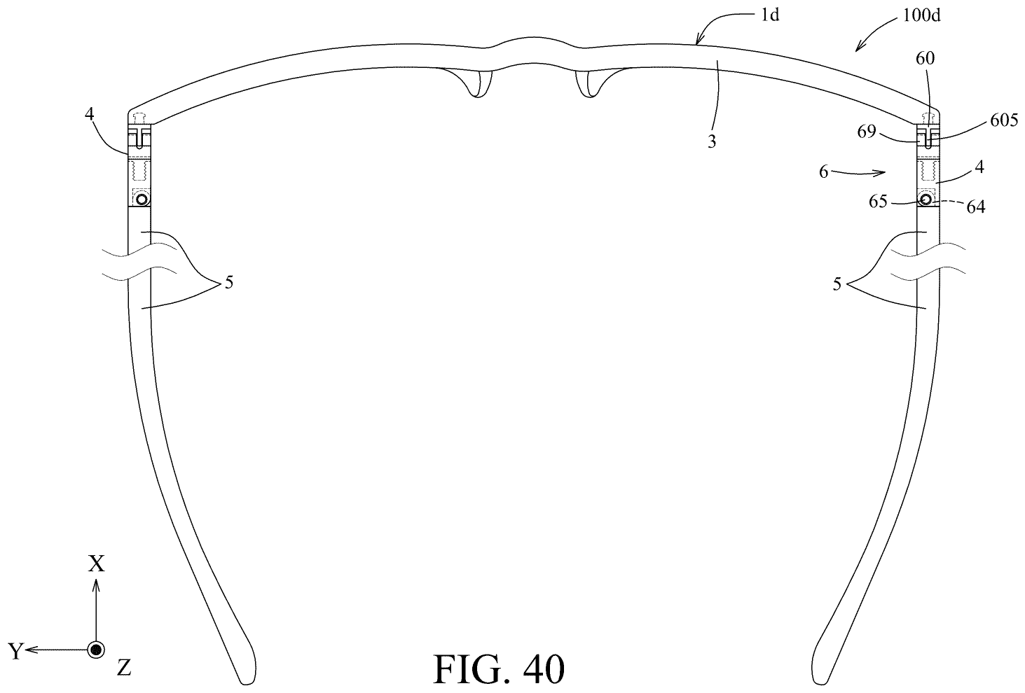

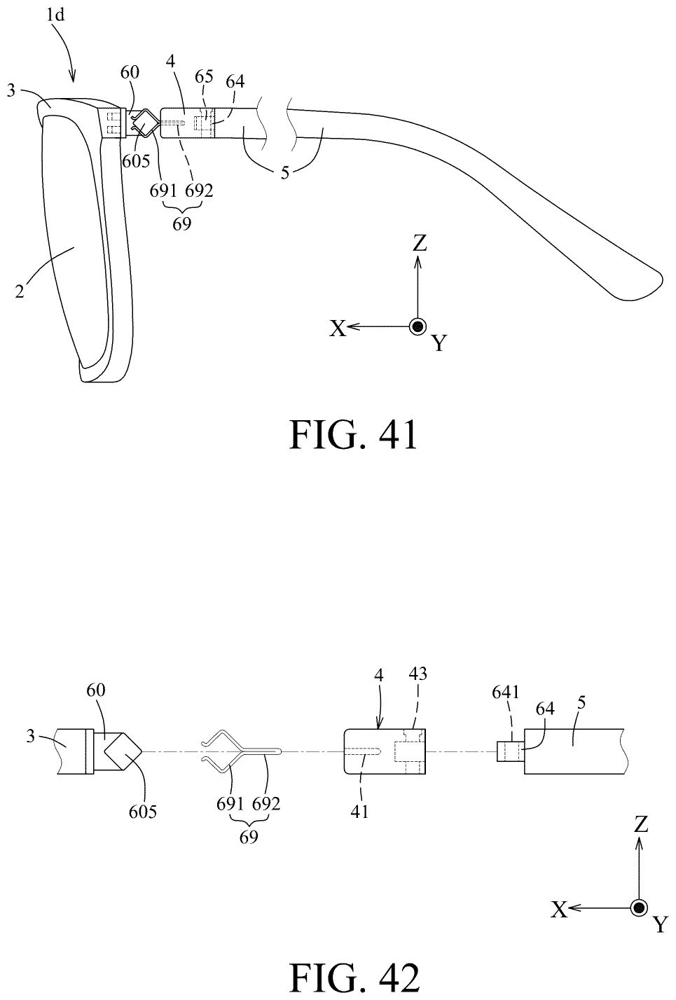

Referring to FIGS. 40 to 42, the seventh embodiment of the eyeglass frame (1d) of the eyeglasses (100d) of this disclosure is shown to be substantially identical to the first embodiment, and differs from the first embodiment in the structures of the temple-connecting arms 4 and the hinge assembly 6.

In this embodiment, the first groove 41 of each temple-connecting arm 4 is in the form of a slot, and the hinge assembly 6 further includes two clamping elastic pieces 69, but does not include the two first shaft pins 61, the two first biasing members 62 and the two first pressing members 63 shown in FIG. 3. Furthermore, each first shaft seat 60 has a pivot portion 605 with a polygonal cross-section. In this embodiment, the pivot portion 605 has a square cross-section, but the cross-section of the pivot portion 605 may be implemented in other shapes according to actual requirements, and is not limited to any specific shape.

Each clamping elastic piece 69 is mounted on the front end of a respective one of the temple-connecting arms 4, and has a chuck structure 691 that corresponds in shape with the pivot portion 605 and that elastically clamping the pivot portion 605, and an embedding structure 692 extending rearwardly from the chuck structure 691 and inserted into the first groove 41 of the respective temple-connecting arm 4. In this embodiment, the clamping elastic piece 69 is made of, for example, metal, and has a certain degree of structural elasticity. The chuck structure 691 has a cross section corresponding to that of the pivot portion 605, that is, a square, and a front side with an opening. Accordingly, when each temple-connecting arm 4 is in a state in which the rear end thereof faces upward, rearward, or downward relative to the lens frame 3, each temple-connecting arm 4 can be maintained in the current state through the matching configuration of the chuck structure 691 and the pivot portion 605 and through the clamping force of the chuck structure 691 against the pivot portion 605 so as to meet the various usage requirements of the user. When it is desired to adjust the rotational position of each temple-connecting arm 4 relative to the lens frame 3, the user can apply force to rotate each temple-connecting arm 4 relative to the lens frame 3. During rotation of the each temple-connecting arm 4 relative to the lens frame 3, the opening of the chuck structure 691 of each clamping elastic piece 69 can be slightly stretched to slightly increase an interior space of the chuck structure 691 so as to provide a sufficient space for rotation of the pivot portion 605. Each temple-connecting arm 4 is rotated until the structural shapes of the chuck structure 691 and the pivot portion 605 match each other again. At this time, the opening of the chuck structure 691 is restored to an original state through an elastic restoring force of the chuck structure 691, so that the chuck structure 691 can once again apply sufficient clamping force to the pivot portion 605 thereby fixing a rotational position of each temple-connecting arm 4 relative to the lens frame 3.

According to the preceding description, in the seventh embodiment, the eyeglass frame (1d) is similarly configured based on the arrangement of the temple-connecting arms 4, the temples 5, and the hinge assembly 6, so that an actuating mechanism that allows the temple-connecting arms 4 to rotate relative to the lens frame 3 in the up-down direction (Z) and the temples 5 to rotate relative to the respective temple-connecting arms 4 in the left-right direction (Y) can be achieved. Thus, regardless of which direction the eyeglasses (100d) are subjected to external forces, the eyeglass frame (1d) of the eyeglasses (100d) can adaptively change the structural form thereof so as to prevent permanent deformation and fracture damage of the structure of the eyeglasses (100d). Furthermore, through the dispositions of the pivot portion 605 of each first shaft seat 60 and the clamping elastic pieces 69, the temple-connecting arms 4 can be structurally positioned at different up and down rotational positions relative to the lens frame 3 so as to meet the various usage requirements of the user.

In summary, the eyeglass frame 1, 1′, 1″, 1a, 1b, 1c, 1d of the eyeglasses 100, 100′, 100″, 100a, 100b, 100c, 100d of this disclosure is configured based on the arrangement of the temple-connecting arms 4, the temples 5, and the hinge assembly 6 to achieve a structural configuration in which the rotational direction of each temple-connecting arms 4 relative to the lens frame 3 is different from the rotational direction of each temple 5 relative to the respective temple-connecting arm 4. Thus, regardless of which direction the eyeglasses 100, 100′, 100″, 100a, 100b, 100c, 100d are subjected to external forces, the eyeglass frame 1, 1′, 1″, 1a, 1b, 1c, 1d of the eyeglasses 100, 100′, 100″, 100a, 100b, 100c, 100d can adaptively change the structural form thereof, thereby preventing permanent deformation fracture damage of the structure of the eyeglasses 100, 100′, 100″, 100a, 100b, 100c, 100d. Therefore, the object of this disclosure can indeed be achieved.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An eyeglass frame comprising:
a lens frame;
two temple-connecting arms having front ends disposed respectively and rotatably on left and right sides of said lens frame, and rear ends opposite to said front ends, each of said temple-connecting arms including a first groove extending inwardly from said front end, and a first shaft hole formed in said front end and communicating transversely with said first groove;
two temples having front ends disposed respectively and rotatably on said rear ends of said temple-connecting arms, a rotating direction of each of said temples relative to the respective one of said temple-connecting arms being different from a rotating direction of each of said temple-connecting arms relative to said lens frame; and
a hinge assembly including
two first shaft seats respectively disposed on said left and right sides of said lens frame, each of said first shaft seats having a first seat body inserted into said first groove of the respective one of said temple-connecting arms, and a first seat hole formed in said first seat body and aligned with said first shaft hole of the respective one of said temple-connecting arms,
two first shaft pins, each of said first shaft pins being inserted into said first shaft hole of the respective one of said temple-connecting arms and said aligned first seat hole,
two first biasing members respectively disposed in said first grooves of said temple-connecting arms and having front ends respectively facing said first seat bodies of said first shaft seats, and
two first pressing members, each of said first pressing members being disposed between and abutting against said front end of one of said first biasing members and said first seat body of a corresponding one of said first shaft seats, each of said first pressing members being capable of abutting against different surfaces of said first seat body of the corresponding one of said first shaft seats when each of said temple-connecting arms is rotated relative to said lens frame, each of said first biasing members generating different biasing forces according to different abutment positions of each of said first pressing members.

2. The eyeglass frame as claimed in claim 1, wherein each of said temple-connecting arms is rotatable relative to said lens frame in an up-down direction, each of said temples being rotatable relative to the respective one of said temple-connecting arms in a left-right direction, each of said first shaft pins extending in the left-right direction.

3. The eyeglass frame as claimed in claim 1, wherein said first seat body has a planar first positioning surface, and a curved first sliding surface connected to said planar first positioning surface.

4. The eyeglass frame as claimed in claim 2, wherein said first seat body has a plurality of planar first positioning surfaces respectively located at rear, top and bottom sides thereof, and a plurality of curved first sliding surfaces each connected between two adjacent ones of said planar first positioning surfaces.

5. The eyeglass frame as claimed in claim 1, wherein each of said temple-connecting arms further includes a second groove extending inwardly from said rear end, and a second shaft hole formed in said rear end and communicating transversely with said second groove, said hinge assembly further including two second shaft seats and two second shaft pins, said second shaft seats being respectively disposed on said front ends of said temples, each of said second shaft seats having a second seat hole aligned with said second shaft hole of the respective one of said temple-connecting arms, each of said second shaft pins being inserted into said second shaft hole of the respective one of said temple-connecting arms and said aligned second seat hole, an extending direction of each of said second shaft pins being different from an extending direction of each of said first shaft pins.

6. The eyeglass frame as claimed in claim 5, wherein:
said second groove of each of said temple-connecting arms communicates with said first groove of the respective one of said temple-connecting arms to form a through hole that extends along a length of the respective one of said temple-connecting arms and that has two openings respectively facing forward and rearward;
each of said second shaft seats further has a second seat body protruding from said front end of the respective one of said temples and inserted into said through hole formed by said first groove and said second groove of the respective one of said temple-connecting arms and formed with said second seat hole;
rear ends of said first biasing members respectively face said second seat bodies of said second shaft seats; and
said hinge assembly further includes two second pressing members, each of said second pressing members being disposed between and abutting against said rear end of said one of said first biasing members and said second seat body of a corresponding one of said second shaft seats, each of said second pressing members being capable of abutting against different surfaces of said second seat body of the corresponding one of said second shaft seats when each of said temples is rotated relative to the respective one of said temple-connecting arms, each of said first biasing members generating different biasing forces according to different abutment positions of each of said second pressing members.

7. The eyeglass frame as claimed in claim 6, wherein said each of said temple-connecting arms is rotatable relative to said lens frame in an up-down direction, each of said temples being rotatable relative to the respective one of said temple-connecting arms in a left-right direction, each of said first shaft pins extending in the left-right direction, each of said second shaft pins extending in the up-down direction.

8. The eyeglass frame as claimed in claim 6, wherein each of said temple-connecting arms is rotatable relative to said lens frame in a left-right direction, each of said temples being rotatable relative to the respective one of said temple-connecting arms in an up-down direction, each of said first shaft pins extending in the up-down direction, each of said second shaft pins extending in the left-right direction.

9. The eyeglass frame as claimed in claim 6, wherein said first seat body has a planar first positioning surface, and a curved first sliding surface connected to said planar first positioning surface, said second seat body having a planar second positioning surface, and a second sliding surface connected to said planar second positioning surface.

10. The eyeglass frame as claimed in claim 7, wherein said first seat body has a plurality of planar first positioning surfaces respectively located at rear, top and bottom sides thereof, and a plurality of curved first sliding surfaces each connected between two adjacent ones of said planar first positioning surfaces, said second seat body having a plurality of planar second positioning surfaces respectively located at front, left and right sides of said second seat body, and a plurality of curved second sliding surfaces each connected between two adjacent ones of said planar second positioning surfaces.

11. The eyeglass frame as claimed in claim 8, wherein said first seat body has a plurality of planar first positioning surfaces respectively located at rear, left and right sides thereof, and a plurality of curved first sliding surfaces each connected between two adjacent ones of said planar first positioning surfaces, said second seat body having a plurality of planar second positioning surfaces respectively located at front, top and bottom sides of said second seat body, and a plurality of curved second sliding surfaces each connected between two adjacent ones of said planar second positioning surfaces.

12. The eyeglass frame as claimed in claim 5, wherein:
each of said second shaft seats further has a second seat body protruding from said front end of the respective one of said temples and inserted into said second groove of the respective one of said temple-connecting arms and formed with said second seat hole; and
said hinge assembly further includes
two second biasing members respectively disposed in said second grooves of said temple-connecting arms, rear ends of said second biasing members respectively facing said second seat bodies of said second shaft seats, and
two second pressing members, each of said second pressing members being disposed between and abutting against said rear end of one of said second biasing members and said second seat body of a corresponding one of said second shaft seats, each of said second pressing members being capable of abutting against different surfaces of said second seat body of the corresponding one of said second shaft seats when each of said temples is rotated relative to the respective one of said temple-connecting arms, each of said second biasing members generating different biasing forces according to different abutment positions of each of said second pressing members.

13. The eyeglass frame as claimed in claim 12, wherein each of said temple-connecting arms is rotatable relative to said lens frame in an up-down direction, each of said temples being rotatable relative to the respective one of said temple-connecting arms in a left-right direction, each of said first shaft pins extending in the left-right direction, each of said second shaft pins extending in the up-down direction.

14. The eyeglass frame as claimed in claim 12, wherein each of said temple-connecting arms is rotatable relative to said lens frame in a left-right direction, each of said temples being rotatable relative to the respective one of said temple-connecting arms in an up-down direction, each of said first shaft pins extending in the up-down direction, each of said second shaft pins extending in the left-right direction.

15. The eyeglass frame as claimed in claim 12, wherein said first seat body has a planar first positioning surface, and a curved first sliding surface connected to said planar first positioning surface, second seat body having a planar second positioning surface, and a second sliding surface connected to said planar second positioning surface.

16. The eyeglass frame as claimed in claim 13, wherein said first seat body has a plurality of planar first positioning surfaces respectively located at rear, top and bottom sides thereof, and a plurality of curved first sliding surfaces each connected between two adjacent ones of said planar first positioning surfaces, said second seat body having a plurality of planar second positioning surfaces respectively located at front, left and right sides of said second seat body, and a plurality of curved second sliding surfaces each connected between two adjacent ones of said planar second positioning surfaces.

17. The eyeglass frame as claimed in claim 14, wherein said first seat body has a plurality of planar first positioning surfaces respectively located at rear, left and right sides thereof, and a plurality of curved first sliding surfaces each connected between two adjacent ones of said planar first positioning surfaces, said second seat body having a plurality of planar second positioning surfaces respectively located at front, top and bottom sides of said second seat body, and a plurality of curved second sliding surfaces each connected between two adjacent ones of said planar second positioning surfaces.

18. The eyeglass frame as claimed in claim 12, wherein said first groove and said second groove of each of said temple-connecting arms extend along a same straight line, and do not communicate with each other.

19. The eyeglass frame as claimed in claim 12, wherein said first groove and said second groove of each of said temple-connecting arms do not extend along a same straight line, and do not communicate with each other.

20. The eyeglass frame as claimed in claim 19, wherein said first groove of each of said temple-connecting arms is located on top of the second groove thereof.

21. The eyeglass frame as claimed in claim 19, wherein said first groove of each of said temple-connecting arms is located below said second groove thereof.

22. An eyeglass frame comprising:
a lens frame;
two temple-connecting arms having front ends connected respectively and rotatably on left and right sides of said lens frame, and rear ends opposite to said front ends, each of said temple-connecting arms including a groove extending inwardly from said front end and along a length of a respective one of said temple-connecting arms, and a shaft hole formed in said front end and communicating transversely with said groove;
two temples having front ends disposed respectively and rotatably on said rear ends of said temple-connecting arms, a rotating direction of each of said temples relative to the respective one of said temple-connecting arms being different from a rotating direction of each of said temple-connecting arms relative to said lens frame, each of said temples including an accommodating groove extending inwardly from said front end and along a length of a respective one of said temples, and a shaft hole formed in said front end of the respective one of said temples and communicating transversely with said accommodating groove; and
a hinge assembly including
two first shaft seats respectively disposed on said left and right sides of said lens frame, each of said first shaft seats having a first seat body inserted into said groove of the respective one of said temple-connecting arms, and a first seat hole formed in said first seat body and aligned with said shaft hole of the respective one of said temple-connecting arms,
two first shaft pins, each of said first shaft pins being inserted into said shaft hole of the respective one of said temple-connecting arms and said aligned first seat hole,
two second shaft seats respectively disposed on said rear ends of said temple-connecting arms, each of said second shaft seats having a second seat body protruding from said rear end of the respective one of said temple-connecting arms and inserted into said accommodating groove of the respective one of said temples, and a second seat hole formed in said second seat body and aligned with said shaft hole of the respective one of said temples,
two second shaft pins, each of said second shaft pins being inserted into said shaft hole of the respective one of said temples and said aligned second seat hole, an extending direction of each of said second shaft pins being different from an extending direction of each of said first shaft pins,
two first biasing members respectively disposed in said grooves of said temple-connecting arms and having front ends respectively facing said first seat bodies of said first shaft seats,
two second biasing members respectively disposed in said accommodating grooves of said temples and having front ends respectively facing said second seat bodies of said second shaft seats,
two first pressing members, each of said first pressing members being disposed between and abutting against said front end of one of said first biasing members and said first seat body of a corresponding one of said first shaft seats, each of said first pressing members being capable of abutting against different surfaces of said first seat body of the corresponding one of said first shaft seats when each of said temple-connecting arms is rotated relative to said lens frame, each of said first biasing members generating different biasing forces according to different abutment positions of each of said first pressing members, and
two second pressing members, each of said second pressing members being disposed between and abutting against said front end of one of said second biasing members and said second seat body of a corresponding one of said second shaft seats, each of said second pressing members being capable of abutting against different surfaces of said second seat body of the corresponding one of said second shaft seats when each of said temples is rotated relative to the respective one of said temple-connecting arms, each of said second biasing members generating different biasing forces according to different abutment positions of each of said second pressing members.

23. The eyeglass frame as claimed in claim 22, wherein each of said temple-connecting arms is rotatable relative to said lens frame in an up-down direction, each of said temples being rotatable relative to the respective one of said temple-connecting arms in a left-right direction, each of said first shaft pins extending in the left-right direction, each of said second shaft pins extending in the up-down direction.

24. The eyeglass frame as claimed in claim 22, wherein each of said temple-connecting arms is rotatable relative to said lens frame in a left-right direction, each of said temples being rotatable relative to the respective one of said temple-connecting arms in an up-down direction, each of said first shaft pins extending in the up-down direction, each of said second shaft pins extending in the left-right direction.

25. The eyeglass frame as claimed in claim 22, wherein said first seat body has a planar first positioning surface, and a curved first sliding surface connected to said planar first positioning surface, said second seat body having a planar second positioning surface, and a second sliding surface connected to said planar second positioning surface.

26. The eyeglass frame as claimed in claim 23, wherein said first seat body has a plurality of planar first positioning surfaces respectively located at rear, top and bottom sides thereof, and a plurality of curved first sliding surfaces each connected between two adjacent ones of said planar first positioning surfaces, said second seat body having a plurality of planar second positioning surfaces respectively located at rear, left and right sides of said second seat body, and a plurality of curved second sliding surfaces each connected between two adjacent ones of said planar second positioning surfaces.

27. The eyeglass frame as claimed in claim 24, wherein said first seat body has a plurality of planar first positioning surfaces respectively located at rear, left and right sides thereof, and a plurality of curved first sliding surfaces each connected between two adjacent ones of said planar first positioning surfaces, said second seat body having a plurality of planar second positioning surfaces respectively located at rear, top and bottom sides of said second seat body, and a plurality of curved second sliding surfaces each connected between two adjacent ones of said planar second positioning surfaces.

28. An eyeglass frame comprising:
a lens frame;
two temple-connecting arms having front ends disposed respectively and rotatably on left and right sides of said lens frame, and rear ends opposite to said front ends, each of said temple-connecting arms including a first shaft hole formed in said front end;
two temples having front ends disposed respectively and rotatably on said rear ends of said temple-connecting arms, a rotating direction of each of said temples relative to the respective one of said temple-connecting arms being different from a rotating direction of each of said temple-connecting arms relative to said lens frame; and
a hinge assembly including
two first shaft seats respectively mounted on said left and right sides of said lens frames, each of said first shaft seats having a first seat hole aligned with said first shaft hole of the respective one of said temple-connecting arms,
two first shaft pins each of said first shaft pins being inserted into said first shaft hole of the respective one of said temple-connecting arms and said aligned first seat hole, and
two magnetic positioning units, each of said magnetic positioning units including a first magnetic member disposed in one of said first shaft seat and said lens frame, and a second magnetic member disposed in a corresponding one of said temple-connecting arms, said first magnetic member and said second magnetic member being magnetically attracted to each other when each of said temple-connecting arms is rotated relative to said lens frame to a predetermined position.

29. The eyeglass frame as claimed in claim 25, wherein each of said temple-connecting arms is rotatable relative to said lens frame in an up-down direction, each of said temples being rotatable relative to the respective one of said temple-connecting arms in a left-right direction, each of said first shaft pins extending in the left-right direction.

30. The eyeglass frame as claimed in claim 28, wherein each of said two temple-connecting arms further includes a second groove extending inwardly from said rear end, and a second shaft hole formed in said rear end and communicating transversely with said second groove said hinge assembly further including two second shaft seats and two second shaft pins, said second shaft seats being respectively disposed on said front ends of said temples, each of said second shaft seats having a second seat hole aligned with said second shaft hole of the respective one of said temple-connecting arms, each of said second shaft pins being inserted into said second shaft hole of the respective one of said temple-connecting arms and said aligned second seat hole, an extending direction of each of said second shaft pins being different from an extending direction of each of said first shaft pins.

31. The eyeglass frame as claimed in claim 28, wherein said first magnetic members of said magnetic positioning units are respectively disposed in rear ends of said first shaft seats, and said first magnetic member and said second magnetic member of each of said magnetic positioning units are adjacent to each other and are magnetically attracted to each other when each of said temple-connecting arms is rotated relative to said lens frame to said predetermined position.

32. The eyeglass frame as claimed in claim 28, wherein each of said two temple-connecting arms further includes an extension section extending forwardly from said front end and formed with a groove, said first magnetic members of said magnetic positioning units being respectively disposed in said left and right sides of said lens frame, said second magnetic members of said magnetic positioning units being respectively disposed in said grooves of said extension sections of said temple-connecting arms, said extension section of each of said temple-connecting arms overlapping with the respective one of said left and right sides of said lens frame in a side-by-side manner when each of said temple-connecting arms is rotated relative to said lens frame to said predetermined position such that said first magnetic member and said second magnetic member of each of said magnetic positioning units are magnetically attracted to each other.

33. An eyeglass frame comprising:
a lens frame;
two temple-connecting arms having front ends disposed respectively and rotatably on left and right sides of said lens frame, and rear ends opposite to said front ends, each of said temple-connecting arms including a first groove extending inwardly from said front end, and a first shaft hole formed in said front end and communicating transversely with said first groove;
two temples having front ends disposed respectively and rotatably on said rear ends of said temple-connecting arms, a rotating direction of each of said temples relative to the respective one of said temple-connecting arms being different from a rotating direction of each of said temple-connecting arms relative to said lens frame; and
a hinge assembly including
two first shaft seats respectively disposed on said left and right sides of said lens frame, each of said first shaft seats having a first seat body inserted into said first groove of the respective one of said temple-connecting arms and abutting against a bottom of said first groove, and a first seat hole formed in said first seat body and aligned with said first shaft hole of the respective one of said temple-connecting arms, said first seat body having a planar first positioning surface, and a curved first sliding surface connected to said planar first positioning surface, and
two first shaft pins, each of said first shaft pins being inserted into said first shaft hole of the respective one of said temple-connecting arms and said aligned first seat hole.

34. The eyeglass frame as claimed in claim 33, wherein each of said temple-connecting arms is rotatable relative to said lens frame in an up-down direction, each of said temples being rotatable relative to the respective one of said temple-connecting arms in a left-right direction, each of said first shaft pins extending in the left-right direction.

35. The eyeglass frame as claimed in claim 33, wherein each of said temple-connecting arms is rotatable relative to said lens frame in a left-right direction, each of said temples being rotatable relative to the respective one of said temple-connecting arms in an up-down direction, each of said first shaft pins extending in the up-down direction.

36. The eyeglass frame as claimed in claim 34, wherein said first seat body has a plurality of said planar first positioning surfaces respectively located at rear, top and bottom sides thereof, and a plurality of said curved first sliding surfaces each connected between two adjacent ones of said planar first positioning surfaces.

37. The eyeglass frame as claimed in claim 35, wherein said first seat body has a plurality of said planar first positioning surfaces respectively located at rear, left and right sides thereof, and a plurality of said curved first sliding surfaces each connected between two adjacent ones of said planar first positioning surfaces.

38. The eyeglass frame as claimed in claim 33, wherein each of said two temple-connecting arms further includes a second groove extending rearwardly from said rear end, and a second shaft hole formed in said rear end and communicating transversely with said second groove, said hinge assembly further including two second shaft seats and two second shaft pins, said second shaft seats being respectively disposed on said front ends of said temples, each of said second shaft seats having a second seat body inserted into said second groove of the respective one of said temple-connecting arms and abutting against a bottom of said second groove, and a second seat hole formed in said second seat body and aligned with said second shaft hole of the respective one of said temple-connecting arms, said second seat body having a planar second positioning surface, and a curved second sliding surface connected to said planar second positioning surface, each of said second shaft pins being inserted into said second shaft hole of the respective one of said temple-connecting arms and said aligned second seat hole, an extending direction of each of said second shaft pins being different from an extending direction of each of said first shaft pins.

39. The eyeglass frame as claimed in claim 38, wherein said first seat body has a plurality of aid planar first positioning surfaces respectively located at rear, top and bottom sides thereof, and a plurality of said curved first sliding surfaces each connected between two adjacent ones of said planar first positioning surfaces, each of said first shaft pins extending in a left-right direction, said second seat body having a plurality of said planar second positioning surfaces located respectively at front, left and right sides of said second seat body, and a plurality of said curved second sliding surfaces each connected between two adjacent one of said second positioning surfaces, each of said second shaft pins extending in an up-down direction.

40. The eyeglass frame as claimed in claim 38, wherein said first seat body has a plurality of said planar first positioning surfaces respectively located at rear, left and right sides thereof, and a plurality of said curved first sliding surfaces each connected between two adjacent ones of said first positioning surfaces, each of said first shaft pins extending in an up-down direction, said second seat body having a plurality of said planar second positioning surfaces respectively located at front, top and bottom sides of said second seat body, and a plurality of said curved second sliding surfaces each connected between two adjacent ones of said second positioning surfaces, each of said second shaft pins extending in a left-right direction.

41. An eyeglass frame comprising:
a lens frame;
two temple-connecting arms having front ends disposed respectively and rotatably on left and right sides of said lens frame, and rear ends opposite to said front ends;
two temples having front ends disposed respectively and rotatably on said rear ends of said temple-connecting arms, a rotating direction of each of said temples relative to the respective one of said temple-connecting arms being different from a rotating direction of each of said temple-connecting arms relative to said lens frame; and
a hinge assembly including
two first shaft seats respectively disposed on said left and right sides of said lens frame, each of said first shaft seats having a pivot portion with a polygonal cross-section, and
two clamping elastic pieces respectively mounted on said front ends of said temple-connecting arms, each of said clamping elastic pieces having a chuck structure that corresponds in shape to said pivot portion and that elastically clamps said pivot portion.

42. The eyeglass frame as claimed in claim 41, wherein each of said temple-connecting arms is rotatable relative to said lens frame in an up-down direction, and each of said temples is rotatable relative to the respective one of said temple-connecting arms in a left-right direction.

43. The eyeglass frame as claimed in claim 41, wherein said pivot portion has a square cross section.

44. The eyeglass frame as claimed in claim 41, wherein each of said temple-connecting arms includes a first groove that is in the form of a slot and that extends inwardly from said front end, and each of said clamping elastic pieces further has an embedding structure extending rearwardly from said chuck structure and inserted into said first groove of the respective one of said temple-connecting arms.

45. The eyeglass frame as claimed in claim 42, wherein each of said temple-connecting arms further includes a second groove extending inwardly from said rear end, and a second shaft hole formed in said rear end and communicating transversely with said second groove, said hinge assembly further including two second shaft seats and two second shaft pins, said second shaft seats being respectively disposed on said front ends of said temples, each of said second shaft seats having a second seat hole aligned with said second shaft hole of the respective one of said temple-connecting arms, each of said second shaft pins 10 being inserted into said second shaft hole of the respective one of said temple-connecting arms and said aligned second seat holes.
